(19) United States
(12) Patent Application Publication
(10) Pub. No.: US 2024/0368437 A1
(43) Pub. Date: Nov. 7, 2024

(54) ADHESIVE COMPOSITION WITH LIGHTWEIGHT FILLER

(71) Applicant: PPG Industries Ohio, Inc., Cleveland, OH (US)

(72) Inventors: Masayuki Nakajima, Wexford, PA (US); Allison Gamble Condie, Valencia, PA (US); Jacob Andrew Singerling, Pittsburgh, PA (US); Marvin Michael Pollum, Jr., Pittsburgh, PA (US)

(73) Assignee: PPG Industries Ohio, Inc., Cleveland, OH (US)

(21) Appl. No.: 18/687,975

(22) PCT Filed: Sep. 9, 2022
(86) PCT No.: PCT/US2022/076161

§ 371 Date: Feb. 29, 2024

Related U.S. Application Data
(60) Provisional application No. 63/242,055, filed on Sep. 9, 2021.

(51) Int. Cl. C09J 11/08; C09J 163/00

(52) U.S. Cl. CPC C09J 11/08; C09J 163/00

(57) ABSTRACT

An adhesive composition including an adhesive compound; and a plurality of particles each comprising an exterior surface comprising a coating deposited thereon wherein the coating comprises a thermoset material and a method or forming an assembly including applying an adhesive composition to a first substrate; and contacting a second substrate to the adhesive composition such that the adhesive composition is located between the first substrate and the second substrate. Also, an assembly including a first substrate and a second substrate and an adhesive composition therebetween and a method of preparing an adhesive composition.

### FIELD

The present disclosure relates to one-component and two-component adhesive compositions and coatings formed therefrom.

### BACKGROUND

The present disclosure is directed towards one-component (1K) and two-component (2K) adhesive compositions that have relatively lower densities than prior adhesive compositions while forming adhesives that maintain mechanical properties.

### SUMMARY

Disclosed herein is an adhesive composition comprising an adhesive compound and a plurality of particles each comprising an exterior surface comprising a coating deposited thereon wherein the coating comprises a thermoset material and/or a reaction product of reactants comprising the thermoset material and a material comprising additional functional groups in addition to those present on the thermoset material.

Also disclosed herein is an assembly comprising: a first substrate; a second substrate; and adhesive composition comprising an adhesive compound and a plurality of particles each comprising an exterior surface comprising a coating deposited thereon wherein the coating comprises a thermoset material and/or a reaction product of reactants comprising the thermoset material and a material comprising additional functional groups in addition to those present on the thermoset material.

Also disclosed herein is a substrate wherein a surface of the substrate is at least partially coated with an adhesive composition comprising an adhesive compound and a plurality of particles each comprising an exterior surface comprising a coating deposited thereon wherein the coating comprises a thermoset material and/or a reaction product of reactants comprising the thermoset material and a material comprising additional functional groups in addition to those present on the thermoset material

### BRIEF DESCRIPTION OF THE DRAWINGS

FIG. 1 shows a cross-section of a coated particle including a solid, i.e., non-hollow or substantially non-hollow, particle having an exterior (outer) surface with a coating shown on (in contact with) the exterior surface of the particle.

FIG. 2 shows a cross-section of a coated particle including a particle having a hollow or substantially hollow core surrounded by wall or shell having an exterior (outer) surface with a coating shown on (in contact with) the exterior surface of the wall or shell of the particle.

### DETAILED DESCRIPTION

For purposes of the following detailed description, it is to be understood that the disclosed subject matter may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the disclosed subject matter. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this description, the use of the singular includes the plural and plural encompasses singular, unless specifically stated otherwise. For example, although reference is made herein to “an” epoxy-containing compound and “a” plurality of particles, a combination (i.e., a plurality) of these components may be used.

In addition, in this application, the use of “or” means “and/or” unless specifically stated otherwise, even though “and/or” may be explicitly used in certain instances.

As used herein, “including.” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on.” “onto,” “applied on,” “applied onto,” “formed on,” “deposited on,” “deposited onto,” “injected on.” “injected onto” and the like mean formed, overlaid, deposited, or provided on, but not necessarily in contact with, a substrate surface. For example, a composition “applied onto” a substrate surface does not preclude the presence of one or more other intervening coating layers or films of the same or different composition located between the composition and the substrate surface.

A “1K” or “one-component” adhesive composition as used herein is a composition in which all of the ingredients may be premixed and stored and wherein the reactive components do not readily react at ambient or slightly thermal conditions, but instead only react upon activation by an external energy source. In the absence of activation from the external energy source, the composition will remain largely unreacted (maintaining sufficient workability in the uncured state and greater than 50 percent of the initial lap shear strength of the composition in the cured state after storage at 25° C. in the uncured state for 8 months). External energy sources that may be used to promote the curing reaction (i.e., the crosslinking of the epoxy component and the curing agent) include, for example, radiation (i.e., actinic radiation) and/or heat.

As used herein, the term “two-component” or “2K” refers to a composition in which at least a portion of the reactive components readily associate to form an interaction or react to form a bond (physically or chemically), and at least partially cure without activation from an external energy source, such as at ambient or slightly thermal conditions, when mixed. One of skill in the art understands that the two components of the composition are stored separately from each other and mixed just prior to application of the composition. Two-component compositions may optionally be heated or baked, as described below.

An “adhesive compound” as used herein is a compound that, when applied to a surface or surfaces of separate substrates and at least partially cured will hold, fasten, or bind the separate substrates together by surface attachment and resist separation. The adhesive compound in an adhesive composition is the component primarily responsible for the mechanical strength and adhesion of the adhesive formed from the adhesive composition.

As used herein, an “adhesive” includes structural adhesives and semi-structural adhesives. As used herein, the term “structural adhesive” means an adhesive formed from an adhesive composition in an at least partially cured state and producing a resistance to cleavage fracture or wedge impact at 25° C. of greater than 10 Newtons per millimeter (N/mm) and a resistance to cleavage fracture or wedge impact at −40° C. of greater than 3 N/mm measured according to ISO 11343 on 0.75 mm thick cold rolled steel (CRS).

As used herein the term “semi-structural adhesive” or “flexible adhesive” means an adhesive formed from an adhesive composition in an at least partially cured state that may typically have a resistance to cleavage fracture or wedge impact at 25° C. of greater than 3 N/mm measured according to ISO 11343 on 0.75 mm thick cold rolled steel (CRS). A “semi-structural adhesive” or “flexible adhesive” may be utilized in a wide variety of applications to bond together two or more substrate materials and may allow for substrate movement without compromising the bond integrity, such as movement due to thermal expansion.

As used herein, the term “glass transition temperature” (“Tg”) refers to the temperature at which an amorphous material, such as a glass or a high molecular weight polymer, changes from a brittle vitreous state to a plastic or rubbery state or from a plastic or rubbery state to a brittle vitreous state. Tg values as used herein can be measured by dynamic mechanical analysis (DMA).

“Ambient” conditions generally refer to room temperature and humidity conditions and may be 10° C. to 32° C. and 20% relative humidity to 80% relative humidity, while slightly thermal conditions are slightly above ambient temperature (e.g., greater than 32° C. to 35° C.) but, in the case of a 1K composition, generally are below the curing temperature for the coating composition, i.e., are generally below those at which the reactive components will readily react and cure.

As used herein, the term “cure”, “cured” or similar terms, as used in connection with the adhesive compositions described herein, means that at least a portion of the components that form an adhesive composition are crosslinked to form an adhesive coating, film, layer, or bond. Additionally, curing of the composition refers to subjecting the adhesive composition to curing conditions (e.g., elevated temperature, lowered activation energy) leading to the reaction of the reactive functional groups of the components of the composition, and resulting in the crosslinking of the components of the composition and formation of an at least partially cured or gelled coating. As used herein, the term “at least partially cured” refers to a coating, film, layer, or bond formed by subjecting the adhesive composition to curing conditions such that a chemical reaction of at least a portion of the reactive groups of the components of the composition occurs to form the coating, film, layer, or bond. The adhesive composition may also be subjected to curing conditions such that a substantially complete cure is attained and wherein further curing results in no significant further improvement in the adhesive properties such as, for example, increased lap shear performance.

As used herein, the term “curing agent” means any reactive material that can be added to a composition to accelerate curing of the composition (e.g., curing of a polymer). The term “reactive” when used with respect to the curing agent means capable of chemical reactions and includes any level of reaction from partial to complete reaction of a reactant.

As used herein, the term “accelerator” means a substance that increases the rate of or decreases the activation energy of a chemical reaction. An accelerator may be either a “catalyst,” that is, without itself undergoing any permanent chemical change, or may be reactive, that is, capable of a chemical reaction and includes any level of reaction from partial to complete reaction of a reactant.

As used herein, the terms “latent” or “blocked” or “encapsulated”, when used with respect to a curing agent or an accelerator, means a molecule or a compound that is activated by an external energy source prior to reacting (i.e., crosslinking) or having a catalytic effect, as the case may be. For example, a latent accelerator may be in the form of a solid at room temperature and have no catalytic effect until it is heated and melts or dissolves in the composition (i.e., “encapsulated”), or the latent accelerator may be reversibly reacted with a second compound that prevents any catalytic effect until the reversible reaction is reversed by the application of heat and the second compound is removed, freeing the accelerator to catalyze reactions (i.e., “blocked”).

As used herein, unless indicated otherwise, the term “substantially free” means that a particular material is not purposefully added to a mixture or composition, respectively, and is only present as an unintentionally added impurity in a trace amount of less than five percent by weight based on a total weight of the mixture or composition, respectively. As used herein, unless indicated otherwise, the term “essentially free” means that a particular material is only present in an amount of less than two percent by weight based on a total weight of the mixture or composition, respectively. As used herein, unless indicated otherwise, the term “completely free” means that a mixture or composition, respectively, does not comprise a particular material, i.e., the mixture or composition comprises zero percent by weight of such material.

As noted above, disclosed herein are 1K (“one-component”) and 2K (“two-component”) adhesive compositions that may be used to treat a variety of substrates or to bond together two substrate materials for a wide variety of potential applications in which the bond between the substrate materials may provide particular mechanical properties related to T-peel strength and/or impact peel strength.

Disclosed herein is an adhesive composition comprising, or consisting essentially of, or consisting of an adhesive compound and a plurality of particles, wherein each of the plurality of particles comprises an exterior surface comprising a coating deposited thereon wherein the coating comprises a thermoset material and/or a reaction product of reactants comprising the thermoset material and a material comprising additional functional groups in addition to those present on the thermoset material.

As described in more detail below, the adhesive composition encompasses a structural adhesive composition and/or a semi-structural adhesive composition or a flexible adhesive composition.

As described in more detail below, the adhesive compositions that form a structural adhesive may comprise a density of less than 1.1 pounds/gal measured according to ASTM D5965 and may, in at least partially cured state, form an adhesive comprising a resistance to cleavage fracture or wedge impact at 25° C. of greater than 14 N/mm measured according to ISO 11343 on 0.75 mm thick cold rolled steel (CRS), a resistance to cleavage fracture or wedge impact at −40° C. of greater than 3 N/mm measured according to ISO 11343 on 0.75 mm thick cold rolled steel (CRS), and/or a relative peel resistance or T-Peel of greater than 2 N/mm measured according to ASTM D1876 on 0.79 mm thick hot dip galvanized (HDG) steel.

As described in more detail below, the adhesive compositions that form a semi-structural adhesive may comprise a density of less than 6 pounds/gal measured according to ASTM D5965 and may, in at least partially cured state, form an adhesive comprising a resistance to cleavage fracture or wedge impact at 25° C. of greater than 3 N/mm measured according to ISO 11343 on 0.75 mm thick cold rolled steel (CRS) and/or a relative peel resistance or T-Peel of greater than 0.5 N/mm measured according to ASTM D1876 on 0.79 mm thick hot dip galvanized (HDG) steel.

As indicated, disclosed herein is an adhesive composition comprising particles, such as microparticles and/or nanoparticles. As used herein, the term “microparticle” refers to small particles with a diameter that falls essentially in the micrometer range, i.e., one micron (μm) or larger, such as 1 μm to 999 μm, such as 1 μm to 250 μm. As used herein, the term “nanoparticle” refers to smaller particles with a diameter that falls essentially in the nanometer range, i.e., less than 1 micron, such as 0.1 nanometers to 999 nanometers (nm), 0.1 to 500 nm 0.1 to 300 nm, 0.1 to 100 nm, or, in some cases, 0.1 to 50 nm. As used herein, a size of a number of microparticles or nanoparticles, as opposed to an individual microparticle or nanoparticle, refers to a distribution of particles with a median diameter that falls in the micrometer or nanometer range. As used herein, the general term particles encompasses both microparticles and nanoparticles. Particles may be measured by scanning electron microscopy (SEM), transmission electron microscopy (TEM) or dynamic light scattering (DLS).

The shape (or morphology) of the particles can vary. For example, generally spherical morphologies (such as solid beads, microbeads, or hollow spheres), can be used, as well as particles that are cubic, platy, or acicular (elongated or fibrous). Additionally, the particles can comprise an internal structure that is hollow, porous, or void free, or a combination of any of the foregoing, e.g., a hollow center with porous or solid walls. For more information on suitable particle characteristics see H. Katz et al. (Ed.), Handbook of Fillers and Plastics (1987) at pages 9-10.

Exemplary, but non-limited, suitable particles comprise particles described in U.S. Patent Application Publication No. 2006/0252881 A1 (U.S. Pat. No. 7,910,634 B2) at paragraphs [0028] to [0055], the cited portion of which being incorporated herein by reference. In the referenced paragraphs, U.S. Patent Application Publication No. 2006/0252881 describes particles formed from polymeric and/or non-polymeric inorganic materials and composite materials (e.g., particles from a primary material that is coated, clad, or encapsulated with a secondary material, including a secondary material that is a different form of the primary material). Examples include, but are not limited to, an inorganic particle formed from an inorganic material, such as silicon carbide or aluminum nitride, with a silica, carbonate or nanoclay coating to form a composite particle; a silane coupling agent with alkyl side chains can interact with the surface of an inorganic particle formed from an inorganic oxide to provide a composite particle; encapsulated or coated particles formed from non-polymeric or polymeric materials with differing non-polymeric or polymeric materials, such as but not limited to DUALITE™, which is a synthetic polymeric particle coated with calcium carbonate that is commercially available from Pierce and Stevens Corporation of Buffalo, New York. The referenced paragraphs of U.S. Patent Application Publication No. 2006/0252881 also describe particles comprising a lamellar structure composed of sheets or plates of atoms in hexagonal array, with strong bonding within the sheet and weak van der Waals bonding between sheets, providing low shear strength between sheets. A non-limiting example of a lamellar structure is a hexagonal crystal structure. Inorganic solid particles comprising a lamellar fullerene (i.e., buckyball) structure are also useful in the compositions disclosed herein. The referenced paragraphs of U.S. Patent Application Publication No. 2006/0252881 further describe particles comprising pigments.

As described in U.S. Patent Application Publication No. 2006/0252881, useful particles can include any inorganic materials known in the art. Suitable particles can be formed from ceramic materials, metallic materials, and mixtures of any of the foregoing. Non-limiting examples of such ceramic materials can comprise metal oxides, mixed metal oxides, metal nitrides, metal carbides, metal sulfides, metal silicates, metal borides, metal carbonates, and mixtures of any of the foregoing. A specific, non-limiting example of a metal nitride is boron nitride; a specific, non-limiting example of a metal oxide is zinc oxide; non-limiting examples of suitable mixed metal oxides are aluminum silicates and magnesium silicates; non-limiting examples of suitable metal sulfides are molybdenum disulfide, tantalum disulfide, tungsten disulfide, and zinc sulfide; non-limiting examples of metal silicates are aluminum silicates and magnesium silicates, such as vermiculite.

The particles may comprise inorganic materials such as aluminum, barium, bismuth, boron, cadmium, calcium, cerium, cobalt, copper, iron, lanthanum, magnesium, manganese, molybdenum, nitrogen, oxygen, phosphorus, selenium, silicon, silver, sulfur, tin, titanium, tungsten, vanadium, yttrium, zinc, and zirconium, including oxides thereof, nitrides thereof, phosphides thereof, phosphates thereof, selenides thereof, sulfides thereof, sulfates thereof, and mixtures thereof. Suitable non-limiting examples of the foregoing inorganic particles include alumina, silica, titania, ceria, zirconia, bismuth oxide, magnesium oxide, iron oxide, aluminum silicate, boron carbide, nitrogen doped titania, and cadmium selenide.

The particles can comprise, for example, a core of essentially a single inorganic oxide, such as silica in colloidal, fumed, or amorphous form, alumina or colloidal alumina, titanium dioxide, iron oxide, cesium oxide, yttrium oxide, colloidal yttria, zirconia, e.g., colloidal or amorphous zirconia, and mixtures of any of the foregoing; or an inorganic oxide of one type upon which is deposited an organic oxide of another type.

The particles can comprise fumed silica, amorphous silica, colloidal silica, alumina, colloidal alumina, titanium dioxide, iron oxide, cesium oxide, yttrium oxide, colloidal yttria, zirconia, colloidal zirconia, and mixtures of any of the foregoing. In certain examples, the particles comprise colloidal silica. As disclosed above, these materials can be surface treated or untreated. Other useful particles include surface-modified silicas, such as are described in U.S. Pat. No. 5,853,809 at column 6, line 51 to column 8, line 43, incorporated herein by reference. The referenced paragraphs describe in part, colloidal silicas having an average diameter of from about 1 to 1000 nanometers (nm), which silicas have been surface-modified with chemically bonded carbon-containing moieties, as well as such groups as anhydrous SiO₂ groups, SiOH groups, various ionic groups physically associated or chemically bonded within the surface of the silica, adsorbed organic groups and combinations thereof.

Non-polymeric, inorganic materials useful in forming the particles can comprise inorganic materials such as graphite, metals, oxides, carbides, nitrides, borides, sulfides, silicates, carbonates, sulfates, and hydroxides. A non-limiting example of a useful inorganic oxide can comprise zinc oxide. Non-limiting examples of suitable inorganic sulfides can comprise molybdenum disulfide, tantalum disulfide, tungsten disulfide, and zinc sulfide. Non-limiting examples of useful inorganic silicates can comprise aluminum silicates and magnesium silicates, such as vermiculite. Non-limiting examples of suitable metals can comprise molybdenum, platinum, palladium, nickel, aluminum, copper, gold, iron, silver, alloys, and mixtures of any of the foregoing.

As another alternative, a particle can be formed from a primary material that is coated, clad, or encapsulated with one or more secondary materials to form a composite material that has a harder surface. Alternatively, a particle can be formed from a primary material that is coated, clad, or encapsulated with a differing form of the primary material to form a composite material that has a harder surface.

In one example, and without limiting the present disclosure, an inorganic particle formed from an inorganic material, such as silicon carbide or aluminum nitride, can comprise a silica, carbonate or nanoclay coating to form a useful composite particle. In another non-limiting example, a silane coupling agent with alkyl side chains can interact with the surface of an inorganic particle formed from an inorganic oxide to provide a useful composite particle comprising a “softer” surface. Other examples can comprise cladding, encapsulating, or coating particles formed from non-polymeric or polymeric materials with differing non-polymeric or polymeric materials. A specific non-limiting example of such composite particles can comprise DUALITE™, which is a synthetic polymeric particle coated with calcium carbonate that is commercially available from Pierce and Stevens Corporation of Buffalo, N.Y.

The particles can be formed from non-polymeric, organic materials. Non-limiting examples of non-polymeric, organic materials useful in the present disclosure include, but are not limited to, stearates (such as zinc stearate and aluminum stearate), diamond, carbon black and stearamide.

The particles can be formed from inorganic polymeric materials. Non-limiting examples of useful inorganic polymeric materials include polyphosphazenes, polysilanes, polysiloxanes, polygermanes, polymeric sulfur, polymeric selenium, silicones and mixtures of any of the foregoing. A specific, non-limiting example of a particle formed from an inorganic polymeric material suitable for use in the present disclosure is Tospearl, which is a particle formed from cross-linked siloxanes and is commercially available from Toshiba Silicones Company, Ltd. of Japan.

The particles can be formed from synthetic, organic polymeric materials. Non-limiting examples of suitable organic polymeric materials can comprise, but are not limited to, thermoset materials and thermoplastic materials. Non-limiting examples of suitable thermoplastic materials can comprise thermoplastic polyesters, such as polyethylene terephthalate, polybutylene terephthalate and polyethylene naphthalate, polycarbonates, polyolefins, such as polyethylene, polypropylene and polyisobutene, acrylic polymers, such as copolymers of styrene and an acrylic acid monomer and polymers containing methacrylate, polyamides, thermoplastic polyurethanes, vinyl polymers, and mixtures of any of the foregoing.

Non-limiting examples of suitable thermoset materials can comprise thermoset polyesters, vinyl esters, epoxy materials, phenolics, aminoplasts, thermoset polyurethanes and mixtures of any of the foregoing. A specific, non-limiting example of a synthetic polymeric particle formed from an epoxy material can comprise an epoxy microgel particle.

The particles can also be hollow particles formed from materials comprising polymeric and non-polymeric inorganic materials, polymeric and non-polymeric organic materials, composite materials, and mixtures of any of the foregoing. Non-limiting examples of suitable materials from which the hollow particles can be formed are described above.

The particles may be lightweight particles. As used herein, the term “lightweight” when used with reference to particles of the present disclosure means that the particles, exclusive of a coating comprising a thermoset material thereon (e.g., prior to deposition of a coating as described herein), have a specific gravity of no more than 0.7, in some cases no more than 0.25 or no more than 0.1 when measured according to ASTM D5965, with “specific gravity” being the ratio of a mass of a solid or liquid (e.g., a mass of particles) to a mass of an equal volume of distilled water at the same temperature (e.g., 25° C.). Suitable lightweight particles of the present disclosure often fall within two categories-microspheres and amorphous particles. The specific gravity of microspheres often ranges from 0.1 to 0.7 when measured according to ASTM D5965 and include, for example, polystyrene foam, microspheres of polyacrylates and polyolefins, and silica microspheres comprising particle sizes ranging from 5 to 100 microns and a specific gravity of 0.25 (ECCOSPHERES®, W. R. Grace & Co.). Other examples can comprise alumina/silica microspheres having particle sizes in the range of 5 to 300 microns and a specific gravity of 0.7 (FILLITE®, Pluess-Stauffer International), aluminum silicate microcells or microspheres such as Sil-Cell microcells (available from Silbrico) and/or those having a specific gravity of from about 0.45 to about 0.7 (Z-LIGHT®), and calcium carbonate-coated polyvinylidene copolymer microspheres having a specific gravity of 0.13 (DUALITE 6001AE®, Pierce & Stevens Corp.) when specific gravity is measured according to ASTM D5965. Amorphous particles may comprise fumed silica. Fumed silica could be hydrophilic or hydrophobic and coated or uncoated. Examples can comprise AEROSIL® fumed silicas from Evonik or HDK® from Wacker Chemie AG. Particle size was determined or confirmed by dispersing the particles on carbon tape attached to aluminum stubs and coated with Au/Pd for 20 seconds. Samples were then analyzed in a Quanta 250 FEG SEM under high vacuum. The accelerating voltage was set to 20.00 kV and the spot size was 3.0. Thirty particles were measured from three different areas to provide a representative particle size distribution for each sample.

The particles may also include thermally expandable capsules. As used herein, the term “thermally expandable capsule” refers to a small hollow shell including a volatile material that expands at a predetermined temperature. Such thermally expandable capsules may have an average initial particle size of at least 5 μm, such as at least 10 μm, and may have an average initial particle size of no more than 70 μm, such as no more than 24 μm, such as no more than 17 μm. The thermally expandable capsules may have an average initial particle size of 5 μm to 70 μm, in some cases 10 μm to 24 μm, and in other cases, 10 μm to 17 μm. As used herein, the term “average initial particle size” refers to the average particle size of the capsules prior to any expansion.

The thermally expandable capsule may comprise a volatile hydrocarbon positioned within a wall of a resin, such as a thermoplastic resin. Examples of hydrocarbons suitable for use in such capsules are, without limitation, methyl chloride, methyl bromide, trichloroethane, dichloroethane, n-butane, n-heptane, n-propane, n-hexane, n-pentane, isobutane, isopentane, iso-octane, neopentane, petroleum ether, and aliphatic hydrocarbons containing fluorine, such as Freon, or a mixture thereof.

Examples of the materials which are suitable for forming the shell or wall of the thermally expandable capsule are, without limitation, polymers of vinylidene chloride, acrylonitrile, styrene, polycarbonate, methyl methacrylate, ethyl acrylate, and vinyl acetate, copolymers of these monomers, and mixtures of the polymers of the copolymers. A crosslinking agent may be used if desired.

Thermally expandable capsules suitable for use in the adhesive compositions disclosed herein are commercially available from various companies, specific examples of which comprise Union Carbide Corporations Ucar and Phenolic Microballoons (phenol balloons), Emerson & Cuming Company's ECCOSPHERES® (epoxy balloons), Emerson & Cuming Company's ECCOSPHERES® VF-O (urea balloons), Dow Chemical Company's Saran Microspheres, AKZO NOBEL's Expancel and Matsumoto Yushi Seiyaku Co., Ltd.'s Matsumoto Microspheres (Saran balloons), Arco Polymers Inc.'s DYLITE® Expandable Polystyrene and BASF-Wyandotte's Expandable Polystyrene Beads (polystyrene balloons), and JSR Corporation's SX863 (P) (crosslinked styrene-acrylic balloons).

As previously indicated, the particles may comprise an exterior surface comprising a coating deposited thereon. Such particles are distinct from particles that are merely encapsulated throughout a polymer network, such as is the case when particles are dispersed in a film-forming binder. Rather, such particles comprise a thin film deposited or otherwise formed on a portion, including an entire portion, of an exterior surface of an individual discrete particle. These resulting coated particles may then subsequently be dispersed in an adhesive compound, thereby resulting in dispersion of the coated particles throughout a polymer network.

At least a portion of the exterior surface of the particles may be covered by a coating. The coating may be a substantially continuous coating covering at least 70 percent of the entire surface area of the particle, such as at least 80 percent, such as at least 90 percent, such as 100 percent. The coating may be a substantially continuous coating covering 70 to 100, 80 to 100, 90 to 100, or 100 percent of the entire surface area of a particle. The coating can comprise a film thickness of no more than 25 micrometers (μm), such as no more than 20 μm, such as no more than 15 μm, or no more than 5 μm. The coating may comprise a film thickness of at least 0.1 nanometers (nm), such as at least 10 nm, or at least 100 nm, or, in some cases, at least 500 nm. The coating may comprise a film thickness of 0.1 nanometers to 25 micrometers, such as 10 nanometers to 20 micrometers, such as 100 nanometers to 20 micrometers, such as 500 nanometers to 15 micrometers, such as 500 nanometers to 5 micrometers. A coating thickness may be measured using optical microscopy with phase-contrast imaging of microtomed samples.

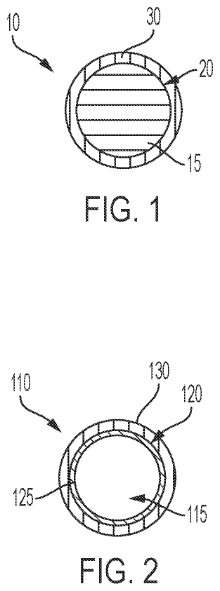

FIG. 1 and FIG. 2 present representations of examples of coated particles of the disclosure. In each example, a coated particle comprises a particle including an exterior surface upon which a film or coating is deposited or otherwise formed. FIG. 1 depicts coated particle 10 including a solid, i.e., non-hollow or substantially non-hollow (e.g., 75 percent to 99 percent solid) particle 15 comprising an exterior (outer) surface 20 as an exterior portion of the particle. Coating 30 is shown on (in contact with) exterior surface 20 of the particle. FIG. 2 depicts coated particle 110 including a particle having a hollow or substantially hollow core 115 surrounded by wall or shell 125. An example may be a thermally expandable capsule that comprises a wall or shell of a material surrounding a hollow core that may or may not comprise a volatile liquid in the core. Coating 130 is shown on (in contact with) an exterior or outer surface 120 of thin wall or shell 125.

The coating on an exterior surface of the particles may comprise a thermoset material, such as thermoset polyesters, vinyl esters, epoxy materials, phenolics, aminoplasts, thermoset polyurethanes and mixtures of any of the foregoing. The coating may comprise a reaction product of reactants comprising the thermoset material and a material comprising additional functional groups in addition to those present on the thermoset material, such as hydroxy functional groups and/or amine functional groups.

Aminoplast resins suitable for use in the preparation of the coated particles include those which are or are derived from at least one of glycoluril, aminotriazine and benzoguanamine. Such compounds comprise, for example, alkoxyalkyl derivatives of melamine, glycoluril, benzoguanamine, acetoguanamine, formoguanamine, spiroguanamine, and the like.

Aminoplast resins may be based on condensation products of an aldehyde, such as formaldehyde, with an amino- or amido-group carrying substance. Condensation products obtained from the reaction of alcohols and formaldehyde with melamine, urea or benzoguanamine are suitable. Condensation products of other amines and amides can also be employed, for example, aldehyde condensates of triazines, diazines, triazoles, guanadines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, glycoluril, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine and 3,4,6-tris(ethylamino)-1,3,5 triazine.

Similar condensation products can be prepared from aldehydes other than formaldehyde such as acetaldehyde, crotonaldehyde, acrolein, benzaldehyde, furfural and glyoxal.

Aminoplast resins can comprise methylol or other alkylol groups, and in most instances, at least a portion of these alkylol groups is etherified by a reaction with an alcohol. Any monohydric alcohol can be employed for this purpose, including alcohols such as methanol, ethanol, propanol, butanol, pentanol, hexanol, heptanol and others, as well as, benzyl alcohol and other aromatic alcohols, cyclic alcohols such as cyclohexanol, monoethers of glycols, and halogen-substituted or other substituted alcohols, such as 3-chloropropanol and butoxyethanol. Commonly employed aminoplast resins include those substantially alkylated with methanol or butanol.

The aminoplast resin may comprise highly alkylated, low imino aminoplast resins which have a degree of polymerization (“DP”) of less than 3.75, often less than 3.0, and, in some cases, less than 2.0. Generally, the number average degree of polymerization is defined as the average number of structural units per polymer chain (see George Odian, Principles of Polymerization, John Wiley & Sons (1991)). For purposes of the disclosure, for example, a DP of 1.0 would indicate a completely monomeric triazine structure, while a DP of 2.0 indicates two triazine rings joined by a methylene or methylene-oxy bridge. Representatively, a DP of less than 3.75 (a mixture of 2 and 3-NHR groups), which would have a nonzero amount of —R groups. A DP less than 2 would come from 2-R groups. Therefore, highly alkylated would be 1-3-R groups (and 0-2-NHR groups) and low alkylation would be 0-1-R groups. It should be understood that the DP values reported herein represent average DP values as determined by gel permeation chromatography data.

Non-limiting examples of suitable aminotriazine compounds can comprise alkoxyalkyl aminotriazines, such as (methoxymethyl) melamine-formaldehyde resin, for example, RESIMENE® CE-7103, 745, and 747 commercially available from Solutia, Inc. and CYMEL® 300, 303; ethylated-methylated benzoguanimine-formaldehyde resin, for example CYMEL® 1123; ethylated-methylated melamine-formaldehyde resin, for example CYMEL® 1116; and methylated-butylated melamine-formaldehyde resin, for example CYMEL® 202, 235, 238, 254, 272, 1135, 1133, 1168 commercially available from Cytec Industries, Inc and RESIMENE® 755, 757 commercially available from Solutia, Inc.

An aminoplast may be reacted with a compound including functional groups reactive therewith to form the thin wall coating or film that is deposited or otherwise formed on the exterior surface of the particles. Suitable functional groups can comprise, without limitation, hydroxyl and thiol groups. As will be appreciated, such groups are reactive with alkylol groups present in the aminoplast resin. Examples of suitable compounds containing hydroxyl groups that are reactive with an aminoplast resin can comprise, but are not limited to, water (e.g., deionized water) and polyols. Examples of suitable compounds containing thiol groups can comprise, but are not limited to, dithiols such as 1,2-ethanedithiol, 1,3-propanedithiol, 1,4-butanedithiol, 1,5-pentanedithiol or 1,6-hexanedithiol.

The coated particles can be prepared by any suitable technique. The coated particles, for example, can be obtained by preparing an aqueous dispersion of particles in water with an aminoplast resin, under stirring. A catalyst may then be added to the dispersion and the dispersion heated to, for example, a temperature of 50° C. to 80° C. A catalyst in this technique is not particularly limited and may include, for example, acids, such as hydrochloric acid, sulfuric acid, p-toluene sulfonic acid, nitric acid, and the like, or inorganic salts showing acidity in aqueous solution, such as aluminum sulfate, alum (ammonium aluminum sulfate), etc.

Following a hold period of, for example, two to three hours, a compound comprising functional groups reactive with the aminoplast resin, such as water or a polyol having hydroxyl functional groups or a thiol containing molecule, may then be added to the aqueous dispersion. The mixture is then held for a period of, for example, two to four hours at a temperature of 50° C. to 80° C. An amount of sodium bicarbonate may then be added to neutralize the acid.

The thus formed exterior surface coated particles may be separated by centrifugal or vacuum filtration, and the wet cake obtained can then be treated, if necessary, with a hot air flow, for example, to obtain a dried product.

The adhesive composition can comprise the coated particles in an amount of no more than 15 percent by weight based on total weight of the adhesive composition, such as no more than 10 percent by weight, such as no more than 7 percent by weight. The adhesive composition can comprise such particles in an amount of at least 0.05 percent by weight based on total weight of the adhesive composition, such as at least 0.1 percent by weight, such as at least 0.2 percent by weight. The adhesive composition can comprise such particles in an amount of 0.05 percent to 15 percent by weight based on total weight of the adhesive composition, such as 0.1 percent to 10 percent by weight, such as 0.2 percent to 7 percent by weight.

The adhesive composition may further comprise an adhesive compound. As described in more detail below, the adhesive compound may comprise a thermoplastic, a thiol-terminated compound, a hydrolysable compound, a compound comprising an electrophilic functional group, or combinations thereof. Optionally, the adhesive compound may further comprise a second compound comprising a nucleophilic functional group. As described in more detail below, the second molecule may be monofunctional or polyfunctional. The second molecule may be a monomer, a small molecule, or a polymer. Suitable nucleophilic functional groups include active hydrogen functional groups including amine functional groups, hydroxy functional groups, thiol functional groups, carboxy functional groups, anhydride functional groups, acetoacetate (ACAC) functional groups, and combinations thereof. Suitable molecules comprising nucleophilic functional groups may comprise an amine, a thiol, an alcohol, a polyol, a carboxylic acid, an anhydride, or combinations thereof. The nucleophilic functional group may be blocked or unblocked or encapsulated or unencapsulated.

Suitable electrophilic functional groups useful in the adhesive compositions disclosed herein include epoxide functional groups, carbonate functional groups, isocyanate functional groups, keto functional groups, aziridine functional groups, thiirane functional groups, cyclic lactone functional groups, and carbodiimide functional groups. The adhesive composition may further comprise a second compound comprising a nucleophilic functional group. The second molecule may be monofunctional or polyfunctional. The second molecule may be a monomer, a small molecule, or a polymer. Suitable nucleophilic functional groups include active hydrogen functional groups including amine functional groups, hydroxy functional groups, thiol functional groups, carboxy functional groups, anhydride functional groups, acetoacetate (ACAC) functional groups, and combinations thereof. Suitable molecules comprising nucleophilic functional groups may comprise an amine, a thiol, an alcohol, a polyol, a carboxylic acid, an anhydride, or combinations thereof. The nucleophilic functional group may be blocked or unblocked or encapsulated or unencapsulated.

Suitable thiol-terminated compounds that may be used in the adhesive compositions include monomers, polymers and/or oligomers.

The composition may comprise a thermoplastic polymer. Suitable thermoplastic polymers include polyamides, such as nylon and aramid; polyolefins, such as polybutadiene, polyisobutylene, polybutene, polymethylpentene, amorphous polypropylene, polyethylene terephthalate, polyethylene, polystyrene, ethylene propylene copolymer, polyvinyl chloride, and vinyl chloride copolymer; polyurethanes; styrene block copolymers, such as styrene-butadiene, styrene-isoprene, styrene-butadiene-styrene, styrene-isoprene-styrene, styrene-ethylene/butylene-styrene, styrene-ethylene/propylene; polyethers such as polyethylene oxide, polypropylene oxide, polyoxymethylene, poly(p-phenylene ether); ethylene-vinylacetate; polybenzimidazole; polyphenylene sulfide; polyether sulfone; polyether ether ketone; chloroprene; acrylonitrile butadiene; polycarbonate; polyacrylates such as poly(meth)acrylate; or combinations thereof. In examples, useful non-reactive elastomers include Polyvest® polybutadiene available from Evonik. Examples of reactive elastomers include Hypro® ATBN amine-functional butadiene copolymer available from Emerald Performance Materials. Suitable examples of thermoplastic elastomers include olefmic thermoplastic elastomers, polyether block amides polybutadiene thermoplastics elastomer, polyester thermoplastic elastomer, styrenic thermoplastic elastomer, and vinyl thermoplastic elastomers, and rubbers such as butadiene rubber, butyl rubber, bromobutyl rubber, chlorobutyl rubber, polyisobutylene rubber, chlorosuflonated polyethylene rubber, epichlorohydrin rubber, ethylene-propylene rubber, fluoroelastomer (vinylidene fluoride-hexafluoropropylene copolymer), natural rubber, neoprene rubber, nitrile rubber, polysulfide rubber, polyurethane rubber, silicone rubber, styrene-butadiene rubber.

The adhesive composition may comprise a hydrolysable component. The hydrolysable component may comprise a silane-containing polymer, a silyl-containing polymer, an imine, or combinations thereof. The silane-containing polymer may comprise a polythioether, a polyester, a polyether, a polyisocyanate, a poly(meth)acrylate, a polyolefin, a polyurea, a polyurethane, or combinations thereof. The silane-containing polymer may comprise an alkoxy group, an acyloxy group, a halogen group, an amino group, or combinations thereof. The silyl-containing polymer may comprise an alkyl group, a phenyl group, or combinations thereof. The silyl-containing polymer may comprise a polythioether, a polysulfide, a thiol ester, a thiol polyacrylate, or combinations thereof. The imine may comprise a ketimine, an aldimine, or combinations thereof.

Suitable examples of compounds useful in the adhesive composition are discussed in: PCT Publ. No. WO 2021/211694A1, pars. [0022] to [0046], to [0059], [0062] to [0138], [0204] and [0206]; PCT Publ. No. WO 2021/211184A1, pars. to [0035], [0044] to [0051], [0056], [0061] to [0080], to [0127], to [0141], [0144] to [0146] and [0150] to [0152]; PCT Publ. No. WO 2021/211183A1, pars. [0017] to [0030], [0040] to [0043], [0046] to [0050], [0081] to [0093], [0101] to [0107], and [0111] to [0113]; and PCT Publ. No. WO 2021/211722A1, pars. [0018] to [0035], [0044] to [0056], [0061], [0062], to [0172], [0203] to [0225], [0233] to [0240] and [0245]; all of which are incorporated herein by reference.

As described above, the electrophilic functional group may comprise an epoxy functional group. An epoxy-containing component or components may be utilized, for example, in a 1K adhesive composition or a 2K adhesive composition. Suitable epoxy-containing components that may be used include monoepoxides, polyepoxides (having an epoxy functionality greater than 1), epoxy adducts or combinations thereof.

Suitable monoepoxides that may be used include monoglycidyl ethers of alcohols and phenols, such as phenyl glycidyl ether, n-butyl glycidyl ether, cresyl glycidyl ether, isopropyl glycidyl ether, glycidyl versatate, for example, CARDURA E available from Shell Chemical Co., and glycidyl esters of monocarboxylic acids such as glycidyl neodecanoate, and mixtures of any of the foregoing.

Suitable polyepoxides (having an epoxy functionality greater than one) can comprise polyglycidyl ethers of Bisphenol A, such as Epon® 828 and 1001 epoxy resins, and Bisphenol F polyepoxides, such as Epon® 862, which are commercially available from Hexion Specialty Chemicals, Inc. of Columbus, Ohio. Other useful polyepoxides can comprise polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, and epoxy novolac resins. Still other non-limiting epoxy components can comprise epoxidized Bisphenol A novolacs, epoxidized phenolic novolacs, epoxidized cresylic novolac, isosorbide diglycidyl ether, triglycidyl p-aminophenol, triglycidyl p-aminophenol bismaleimide, triglycidyl isocyanurate, tetraglycidyl 4,4′-diaminodiphenylmethane, and tetraglycidyl 4,4′-diaminodiphenylsulphone. The epoxy-containing component may also comprise an epoxy-dimer acid adduct. The epoxy-dimer acid adduct may be formed as the reaction product of reactants comprising a diepoxide compound (such as a polyglycidyl ether of Bisphenol A) and a dimer acid (such as a C36 dimer acid). The epoxy-containing component may also comprise a carboxyl-terminated butadiene-acrylonitrile copolymer modified epoxy-containing compound. The epoxy-containing component may also comprise an epoxidized oil such as an epoxidized natural oil such as epoxidized castor oil. The epoxy-containing compound may also comprise an epoxy-containing acrylic, such as glycidyl methacrylate.

The epoxy-containing component may comprise an epoxy-adduct. The composition may comprise one or more epoxy-adducts. As used herein, the term “epoxy-adduct” refers to a reaction product comprising the residue of an epoxy and at least one other compound that does not include an epoxide functional group. For example, the epoxy-adduct may comprise the reaction product of reactants comprising: (1) an epoxy compound, a polyol, and an anhydride; (2) an epoxy compound, a polyol, and a diacid; or (3) an epoxy compound, a polyol, an anhydride, and a diacid.

The epoxy used to form the epoxy-adduct may comprise any of the epoxy-containing compounds listed above that may be included in the composition.

The polyol used to form the epoxy-adduct may include diols, triols, tetraols and higher functional polyols. Combinations of such polyols may also be used. The polyols may be based on a polyether chain derived from ethylene glycol, propylene glycol, butylene glycol, hexylene glycol and the like as well as mixtures thereof. The polyols may be based on a polyether chain derived from ethylene glycol, propylene glycol, butylene glycol, hexylene glycol and the like, as well as mixtures thereof. The polyol may also be based on a polyester chain derived from ring opening polymerization of caprolactone (referred to as polycaprolactone-based polyols hereinafter). Suitable polyols may also comprise polyether polyols, polyurethane polyols, polyurea polyols, acrylic polyols, polyester polyols, polybutadiene polyols, hydrogenated polybutadiene polyols, polycarbonate polyols, polysiloxane polyols, and combinations thereof. Polyamines corresponding to polyols may also be used, and in this case, amides instead of carboxylic esters will be formed with the anhydrides.

The polyol may comprise a polycaprolactone-based polyol. The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® PTMEG 250 and Terathane® PTMEG 650 which are blends of linear diols in which the hydroxyl groups are separated by repeating tetramethylene ether groups, available from Invista. In addition, polyols based on dimer diols sold under the trade names Pripol®, Solvermol™ and Empol®, available from Cognis Corporation (BASF), or bio-based polyols, such as the tetrafunctional polyol Agrol 4.0, available from BioBased Technologies, LLC (Cargill) may also be utilized.

The anhydride that may be used to form the epoxy-adduct may comprise any suitable acid anhydride known in the art. For example, the anhydride may comprise hexahydrophthalic anhydride and its derivatives (e.g., methyl hexahydrophthalic anhydride); phthalic anhydride and its derivatives (e.g., methyl phthalic anhydride); maleic anhydride; succinic anhydride; trimelletic anhydride; pyromelletic dianhydride (PMDA); 3,3′,4,4′-oxydiphthalic dianhydride (ODPA); 3,3′,4,4′-benzopherone tetracarboxylic dianhydride (BTDA); and 4,4′-diphthalic (hexafluoroisopropylidene) anhydride (6FDA).

The diacid used to form the epoxy-adduct may comprise any suitable diacid known in the art. For example, the diacids may comprise phthalic acid and its derivates (e.g., methyl phthalic acid), hexahydrophthalic acid and its derivatives (e.g., methyl hexahydrophthalic acid), maleic acid, succinic acid, adipic acid, and the like.

The epoxy-adduct may comprise a diol, a monoanhydride, and a diepoxy compound, wherein the mole ratio of diol, monoanhydride, and diepoxy compounds in the epoxy-adduct may vary from 0.5:0.8:1.0 to 0.5:1.0:6.0.

The epoxy-adduct may comprise a triol, a monoanhydride, and a diepoxy compound, wherein the mole ratio of triol, monoanhydride, and diepoxy compounds in the epoxy-adduct may vary from 0.5:0.8:1.0 to 0.5:1.0:6.0.

The epoxy-adduct may comprise a tetraol, a monoanhydride, and a diepoxy compound, wherein the mole ratio of tetraol, monoanhydride, and diepoxy compounds in the epoxy-adduct may vary from 0.5:0.8:1.0 to 0.5:1.0:6.0.

Other suitable epoxy-containing components can comprise epoxy-adducts such as epoxy polyesters formed as the reaction product of reactants comprising an epoxy-containing compound, a polyol and an anhydride or an epoxy-adduct formed as the reaction product of reactants comprising an epoxy-containing compound, a polyol, and a diacid or an epoxy-adduct formed as the reaction product of reactants comprising an epoxy-containing compound, a polyol, an anhydride and a diacid, as described in U.S. Pat. No. 8,796,361, col. 3, line 42 through col. 4, line 65, the cited portion of which is incorporated herein by reference.

The epoxy-containing component may comprise an average epoxide functionality of greater than 1.0, such as at least 1.8, and may comprise an average epoxide functionality of less than 3.2, such as no more than 2.8. The epoxy-containing component may have an average epoxide functionality of greater than 1.0 to less than 3.2, such as 1.8 to 2.8. As used herein, the term “average epoxide functionality” means the molar ratio of epoxide functional groups to epoxide-containing molecules in the composition.

According to the present disclosure, the epoxy equivalent weight of the epoxy-containing component of the coating composition may comprise at least 40 g/eq, such as at least 74 g/eq, such as at least 160 g/eq, such as at least 200 g/eq, such as at least 500 g/eq, such as at least 1,000 g/eq, and in some cases may be no more than 5000 g/eq, such as no more than 4000 g/eq, such as no more than 3,000 g/eq, such as no more than 2,000 g/eq, such as no more than 1,000 g/eq, such as no more than 500 g/eq, such as no more than 200 g/eq. According to the present disclosure, the epoxy equivalent weight of the epoxy-containing component of the coating composition can range from 40 g/eq to 2,000 g/eq, such as from 100 g/eq to 1,000 g/eq, such as from 160 g/eq to 500 g/eq. As used herein, the “epoxy equivalent weight” is determined by dividing the molecular weight of the epoxy-containing component by the number of epoxy groups present in the epoxy-containing component.

According to the present disclosure, the number average molecular weight (Mn) of the epoxy-containing component of the coating composition determined by gel permeation chromatography may comprise at least 40 g/mol, such as at least 74 g/mol, such as at least 198 g/mol, such as at least 310 g/mol, such as at least 500 g/mol, such as at least 1,000 g/mol, and in some cases no more than 20,000 g/mol, such as no more than 4,000 g/mol, such as no more than 2,000 g/mol, such as no more than 400 g/mol, such as no more than 300 g/mol. According to the present disclosure, the Mn of the epoxy-containing component of the coating composition can range from 40 g/mol to 20,000 g/mol, such as from 198 g/mol to 4,000 g/mol, such as from 310 g/mol to 2,000 g/mol, such as from 500 g/mol to 1,000 g/mol.

In another example, the epoxy-containing component of the adhesive composition may further comprise elastomeric particles. Any elastomeric particles included in the epoxy-containing component of the adhesive composition are described with reference to the adhesive compound component in an adhesive composition and not the plurality of particles component of the adhesive composition that comprise an exterior surface including a coating deposited thereon wherein the coating comprises an aminoplast resin. As used herein, “elastomeric particles” refers to particles comprised of one or more materials comprising at least one glass transition temperature (Tg) of greater than −150° C. and less than 30° C., measured, for example, using DMA. The elastomeric particles may be phase-separated from the epoxy in the epoxy-containing component. As used herein, the term “phase-separated” means forming a discrete domain within a matrix of the epoxy-containing component.

The elastomeric particles may comprise a core/shell structure. Suitable core-shell elastomeric particles may be comprised of an acrylic shell and an elastomeric core. The core may comprise natural or synthetic rubbers, polybutadiene, styrene-butadiene, polyisoprene, chloroprene, acrylonitrile butadiene, butyl rubber, polysiloxane, polysulfide, ethylene-vinyl acetate, fluoroelastomer, polyolefin, hydronated styrene-butadiene, or combinations thereof.

The elastomeric particles may optionally be included in an epoxy carrier resin for introduction into the coating composition. Suitable finely dispersed core-shell elastomeric particles in an average particle size ranging from 20 nm to 400 nm may be master-batched in epoxy resin such as aromatic epoxides, phenolic novolac epoxy resin, bisphenol A and/or bisphenol F diepoxide, and/or aliphatic epoxides, which comprise cyclo-aliphatic epoxides, at concentrations ranging from 1 percent to 80 percent core-shell elastomeric particles by weight based on the total weight of the elastomeric dispersion, such as from 5 percent to 50 percent, such as from 15 percent to 40 percent. Suitable epoxy resins may also comprise a mixture of epoxy resins. When utilized, the epoxy carrier resin may be an epoxy-containing component such that the weight of the epoxy-containing component present in the coating composition includes the weight of the epoxy carrier resin.

Exemplary non-limiting commercial core-shell elastomeric particle products using poly(butadiene) rubber particles that may be utilized in the adhesive composition of the present disclosure comprise core-shell poly(butadiene) rubber powder (commercially available as PARALOID™ EXL 2650A from Dow Chemical), a core-shell poly(butadiene) rubber dispersion (25% core-shell rubber by weight) in bisphenol F diglycidyl ether (commercially available as Kane Ace MX 136), a core-shell poly(butadiene) rubber dispersion (33 percent core-shell rubber by weight) in Epon® 828 (commercially available as Kane Ace MX 153), a core-shell poly(butadiene) rubber dispersion (33 percent core-shell rubber by weight) in Epiclon® EXA-835LV (commercially available as Kane Ace MX 139), a core-shell poly(butadiene) rubber dispersion (37 percent core-shell rubber by weight) in bisphenol A diglycidyl ether (commercially available as Kane Ace MX 257), and a core-shell poly(butadiene) rubber dispersion (37 percent core-shell rubber by weight) in Epon® 863 (commercially available as Kane Ace MX 267), a siloxane rubber dispersion in bisphenol F diglydicyl ether (commercially available as Kane Ace MX-960), each available from Kaneka Texas Corporation, and acrylic rubber dispersions.

Exemplary non-limiting commercial core-shell elastomeric particle products using styrene-butadiene rubber particles that may be utilized in the adhesive composition can comprise a core-shell styrene-butadiene rubber powder (commercially available as CLEARSTRENGTH® XT100 from Arkema), core-shell styrene-butadiene rubber powder (commercially available as PARALOID™ EXL 2650J), a core-shell styrene-butadiene rubber dispersion (33 percent core-shell rubber by weight) in bisphenol A diglycidyl ether (commercially available as Fortegra™ 352 from Olin™), core-shell styrene-butadiene rubber dispersion (33 percent rubber by weight) in low viscosity bisphenol A diglycidyl ether (commercially available as Kane Ace MX 113), a core-shell styrene-butadiene rubber dispersion (25 percent core-shell rubber by weight) in bisphenol A diglycidyl ether (commercially available as Kane Ace MX 125), a core-shell styrene-butadiene rubber dispersion (25 percent core-shell rubber by weight) in bisphenol F diglycidyl ether (commercially available as Kane Ace MX 135), a core-shell styrene-butadiene rubber dispersion (25 percent core-shell rubber by weight) in D.E.N.™-438 phenolic novolac epoxy (commercially available as Kane Ace MX 215), a core-shell styrene-butadiene rubber dispersion (25 percent core-shell rubber by weight) in Araldite® MY-721 multi-functional epoxy (commercially available as Kane Ace MX 416), a core-shell styrene-butadiene rubber dispersion (25 percent core-shell rubber by weight) in MY-0510 multi-functional epoxy (commercially available as Kane Ace MX 451), a core-shell styrene-butadiene rubber dispersion (25 percent core-shell rubber by weight) in Syna Epoxy 21 Cyclo-aliphatic Epoxy from Synasia (commercially available as Kane Ace MX 551), and a core-shell styrene-butadiene rubber dispersion (25 percent core-shell rubber by weight) in polypropylene glycol (MW 400) (commercially available as Kane Ace MX 715), each available from Kaneka Texas Corporation.

Exemplary non-limiting commercial core-shell elastomeric particle products using polysiloxane rubber particles that may be utilized in the adhesive composition of the present disclosure comprise a core-shell polysiloxane rubber powder (commercially available as GENIOPERL® P52 from Wacker), a core-shell polysiloxane rubber dispersion (40 percent core-shell rubber by weight) in bisphenol A diglycidyl ether (commercially available as ALBIDUR EP2240A from Evonick), a core-shell polysiloxane rubber dispersion (25 percent core-shell rubber by weight) in jER™828 (commercially available as Kane Ace MX 960), a core-shell polysiloxane rubber dispersion (25 percent core-shell rubber by weight) in Epon® 863 (commercially available as Kane Ace MX 965) each available from Kaneka Texas Corporation.

The epoxy-containing component may comprise the elastomeric particles in an amount of at least 0.5 percent by weight based on the total composition weight, such as at least 10 percent, and in some cases may be present in the composition in an amount of no more than 80 percent by weight based on the total composition weight, such as no more than 50 percent. According to the present disclosure, the epoxy-containing component may comprise the elastomeric particles in an amount of from greater than 0.5 percent by weight to 80 percent by weight based on the total composition weight, such as 10 percent by weight to 50 percent by weight.

The average particle size of the core-shell elastomeric particles may be at least 20 nm, as measured by transmission electron microscopy (TEM), such as at least 30 nm, such as at least 40 nm, such as at least 50 nm, and may be no more than 400 nm, such as no more than 300 nm, such as no more than 200 nm, such as no more than 150 nm. The average particle size of the elastomeric particles may be 20 nm to 400 nm as measured by TEM, such as 30 nm to 300 nm, such as 40 nm to 200 nm, such as 50 nm to 150 nm. Suitable methods of measuring particle sizes by TEM include suspending elastomeric particles in a solvent selected such that the particles do not swell, and then drop casting the suspension onto a TEM grid which is allowed to dry under ambient conditions. For example, epoxy resin containing core-shell rubber elastomeric particles from Kaneka Texas Corporation can be diluted in butyl acetate for drop casting. Particle size measurements may be obtained from images acquired using a Tecnai T20 TEM operating at 200 kV and analyzed using ImageJ software, or an equivalent instrument and software.

The molecule comprising the nucleophilic functional group may comprise a diamine comprising a cyclic ring and/or a polyamine comprising a cyclic ring and includes ortho-, meta-, and para-isomers of aromatic diamines and polyamines or any mixtures of these isomers. The diamine and/or polyamine comprising a cyclic ring also comprises amines containing non-aromatic ring structures such as aliphatic rings and/or heterocyclic rings. The diamine and/or the polyamine may be used to at least partially cure the composition by reacting with an epoxy-containing component to form a polymeric matrix upon combination.

In examples, the diamine and/or the polyamine may contain a cyclic ring. The cyclic ring may be intermolecular or may be pendant. For example, the diamine and/or the polyamine may comprise an aromatic ring such as xylylene diamine, phenylene diamine, methylenedianiline, diaminotoluene, diaminophenol, diamino diphenyl sulfone, 4,4′-oxydianiline, diethyl toluene diamine, methyl-bis(methylthio)benzenediamine (Ethacure 300, for example, available from Albemarle), aminobenzylamine, 5,5′-methylenedifurfurylamine, 5,5′-ethylidenedifurfurylamine, or combinations thereof. The diamine and/or polyamine may also comprise a non-aromatic cyclic ring such as isophorone diamine, 4,4-diaminodicyclohexylmethane, diaminocyclohexane, bis(aminomethyl) norbornane, bis(aminomethyl)cyclohexane, piperazine, aminoethylpiperazine, bis(aminopropyl) piperazine, or combinations thereof.

In other examples, the molecule comprising the nucleophilic functional group may comprise an oligomeric cyclic ring-containing diamine or polyamine in addition to the diamine and/or the polyamine described above. As used herein, the term “oligomer” refers to a molecular complex of monomers having a finite number of repeating units. Optionally, the amino-functional oligomer may contain a cyclic ring. In an example, the amine-functional oligomer may comprise an oligomeric amine reaction product of xylylene diamine and epichlorohydrin, which is commercially available as Gaskamine 328 (Mitsubishi Gas). In an example, the amine-functional oligomer may comprise one of the following structures:

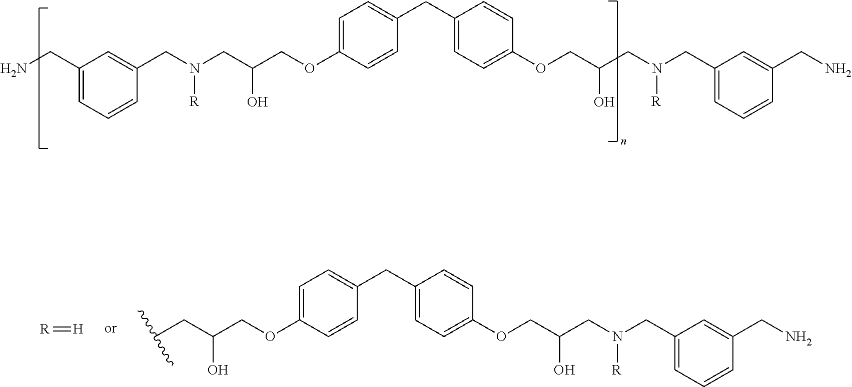

where n is at least 1 and the presence of R substituents on the amine demonstrate the possibility of branched structures. In other examples, the molecule comprising the nucleophilic functional group may comprise a cyclic ring containing diamine partially reacted with a monofunctional epoxide.

Optionally, in addition to the diamine or polyamine containing a cyclic ring, the molecule comprising the nucleophilic functional group may additionally comprise a monoamine, diamine, or polyamine. Useful monoamines include, but are not limited to, aniline, ethanolamine. N-methylethanolamine, butylamine, benzylamine, allylamine, ethylhexylamine, polypropylene glycol monoamines such as Jeffamine-M600 and Jeffamine M-2005 available from Huntsman, polyethylene glycol monoamines such as Jeffamine M-1000 and Jeffamine M-2070 available from Huntsman. Useful diamines include, but are not limited to, ethylenediamine, tetramethylenediamine, hexamethylenediamine, 2-methylpentamethylenediamine (available as Dytek A from Invista), polyether diamines such as those of the Jeffamine D. ED, or EDR series available from Huntsman. Useful polyamines include but are not limited to diethylenetriamine, triethylenetetramine, tetraethylenepentamine, tris(2-aminoethyl)amine, tris(3-aminopropyl)amine, and trifunctional polyether amines such as the Jeffamine T-403, Jeffamine T-3000, and Jeffamine T-5000 available from Huntsman. In another example, the curing agent may comprise the reaction product of excess xylylene diamine and glycidol, having the following structure:

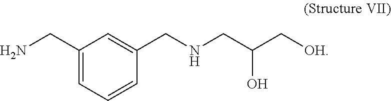 [SMILES: NCc1cccc(CNCC(O)CO)c1]

Optionally, the molecule comprising the nucleophilic functional group may comprise a diamine comprising a cyclic ring and/or a polyamine comprising a cyclic ring in an amount of at least 20 percent by weight based on total weight of all monoamines, diamines and/or polyamines present in the curing agent, such as at least 30 percent by weight, such as at least 40 percent by weight, such as at least 50 percent by weight, and may comprise a diamine comprising a cyclic ring and/or a polyamine comprising a cyclic ring in an amount of 100 percent by weight based on total weight of all monoamines, diamines and/or polyamines in the second component, such as no more than 90 percent by weight, such as no more than 80 percent by weight, such as no more than 70 percent by weight, such as no more than 60 percent by weight. The molecule may comprise a diamine comprising a cyclic ring and/or a polyamine comprising a cyclic ring in an amount of 20 percent by weight to 100 percent by weight based on total weight of all monoamines, diamines, and/or polyamines present, such as 30 percent by weight to 90 percent by weight, such as 40 percent by weight to 80 percent by weight, such as 50 percent by weight to 70 percent by weight. In an example, the cyclic ring may comprise a benzene. In an example, the diamine comprising a cyclic ring may comprise xylylene diamine.

The adhesive composition may comprise the diamine and/or polyamine curing agent in an amount sufficient to provide a molar ratio of epoxide functional groups from the epoxy-containing component to amine-hydrogens from the diamine and/or polyamine curing agent of at least 0.5:1.0, such as at least 0.75:1.0, and may be present in the composition in amount to provide a molar ratio of epoxide functional groups from the epoxy-containing component to amine-hydrogens from the diamine and/or polyamine curing agent of no more than 1.5:1.0, such as no more than 1.25 to 1.0. The adhesive composition may comprise the diamine and/or polyamine curing agent in an amount sufficient to provide a molar ratio of epoxide functional groups from the epoxy-containing component to amine-hydrogens from the diamine and/or polyamine curing agent of 0.5:1.0 to 1.5:1.0, such as 0.75:1.0 to 1.25 to 1.0.

The adhesive composition of the present disclosure optionally may further comprise an accelerator. The accelerator may comprise a latent accelerator such as an encapsulated accelerator a non-encapsulated accelerator, a blocked accelerator, or combinations thereof. The latent accelerator may be activatable by an external energy source such as an elevated temperature (e.g., a temperature greater than ambient temperature). For example, the latent accelerator may be present in the adhesive composition in a solid state at ambient temperature or slightly thermal temperatures (e.g., greater than ambient temperature but less than 100° C.). In a solid state, the accelerator is non-reactive or substantially non-reactive with the isocyanate-functional prepolymer or the epoxy-containing component. Upon exposure to an elevated temperature as an external energy source (e.g., a temperature greater than 100° C.), the latent accelerator may melt or transition from a solid state to a liquid state. As a melt or in a liquid state, the latent accelerator may react with the epoxy-containing component in the adhesive composition (e.g., cross-link with the epoxy-containing component).

A suitable latent accelerator may comprise an accelerator having two or more amine groups (a polyamine). Preferable polyamines are polyamines that are latent at ambient temperature or slightly thermal temperature and may be activated to react (e.g., cross-link) with the epoxy-containing component when the composition is exposed to external energy source such as a high temperature (e.g., an activation temperature of 100° C. or greater or an activation temperature between 100° C. and 350° C.).

In examples, the latent accelerator may comprise, or consist essentially of, or consist of, a guanidine. It will be understood that “guanidine,” as used herein, refers to guanidine and derivatives thereof. For example, the accelerator that may be used comprises guanidines, substituted guanidines, substituted ureas, melamine resins, guanamine derivatives, heat-activated cyclic tertiary amines, aromatic amines and/or mixtures thereof. Examples of substituted guanidines comprise methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine (dicyandiamide, e.g., Dyhard® available from AlzChem). Representatives of suitable guanamine derivatives which may be mentioned comprise alkylated benzoguanamine resins, benzoguanamine resins or methoxymethylethoxymethylbenzoguanamine.

For example, the guanidine may comprise a compound, moiety, and/or residue comprising the following general structure:

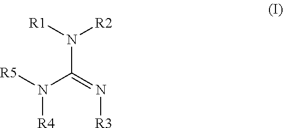

wherein each of R1, R2, R3, R4, and R5 (i.e., substituents of structure (I)) comprise hydrogen, (cyclo)alkyl, aryl (e.g., a C5-C10 aryl), organometallic (e.g., containing a metallic or semimetallic heteroatom), a polymeric structure (e.g., containing repeating (cyclo)alkyl and/or aryl monomers), or together can form a cycloalkyl, or an aryl structure, and wherein R1, R2, R3, R4, and R5 may be the same or different. As used herein, “(cyclo)alkyl” refers to both alkyl and cycloalkyl (e.g., a C1-C12 alkyl, a C3-C12 cycloalkyl). When any of the R groups “together can form a (cyclo)alkyl and/or aryl group”, it is meant that any two adjacent R groups are connected to form a cyclic moiety, such as the rings in structures (II)-(V) below.

It will be appreciated that the double bond between the carbon atom and the nitrogen atom that is depicted in structure (I) may be located between the carbon atom and another nitrogen atom of structure (I). Accordingly, the various substituents of structure (I) may be attached to different nitrogen atoms depending on where the double bond is located within the structure.

The guanidine may comprise a cyclic guanidine such as a guanidine of structure (I) wherein two or more R groups of structure (I) together form one or more rings. In other words, the cyclic guanidine may comprise ≥1 ring(s). For example, the cyclic guanidine may either be a monocyclic guanidine (1 ring) such as depicted in structures (II) and (III) below, or the cyclic guanidine may be bicyclic or polycyclic guanidine (≥2 rings) such as depicted in structures (IV) and (V) below.

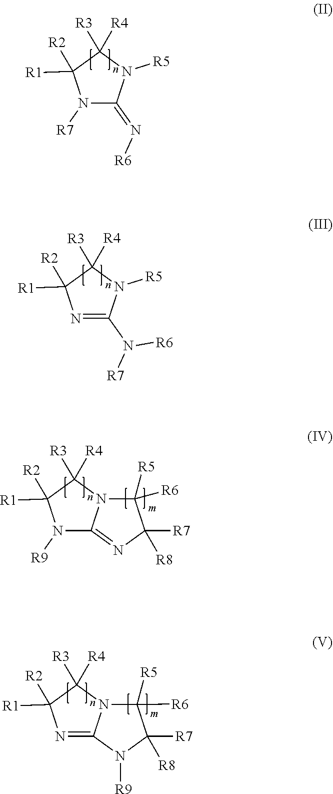

Each substituent of structures (II) and/or (III), n and m, if present, may comprise 1 to 6 and R1-R7, may comprise hydrogen, (cyclo)alkyl (e.g., a C1-C12 alkyl, a C3-C12 cycloalkyl), aryl (e.g., a C6-C10 aryl), aromatic, organometallic, a polymeric structure, or together can form a cycloalkyl, aryl, or an aromatic structure, and wherein R1-R7 may be the same or different. Similarly, each substituent of structures (IV) and (V), R1-R9, may comprise hydrogen, alkyl (e.g., a C1-C12 alkyl), aryl (e.g., a C6-C10 aryl), aromatic, organometallic, a polymeric structure, or together can form a cycloalkyl (e.g., a C1-C12 alkyl, a C3-C12 cycloalkyl), aryl (e.g., a C6-C10 aryl), or an aromatic structure, and wherein R1-R9 may be the same or different. Moreover, in some examples of structures (II) and/or (III), certain combinations of R1-R7 may be part of the same ring structure. For example, R1 and R7 of structure (II) may form part of a single ring structure. Moreover, it will be understood that any combination of substituents (R1-R7 of structures (II) and/or (III) as well as R1-R9 of structures (IV) and/or (V)) may be chosen so long as the substituents do not substantially interfere with the catalytic activity of the cyclic guanidine.

Each ring in the cyclic guanidine may be comprised of five or more (≥5) members. For example, the cyclic guanidine may comprise a 5-member ring, a 6-member ring, and/or a 7-member ring. As used herein, the term “member” refers to an atom located in a ring structure. Accordingly, a 5-member ring will have 5 atoms in the ring structure (“n” and/or “m”=1 in structures (II)-(V)), a 6-member ring will have 6 atoms in the ring structure (“n” and/or “m”=2 in structures (II)-(V)), and a 7-member ring will have 7 atoms in the ring structure (“n” and/or “m”=3 in structures (II)-(V)). It will be appreciated that if the cyclic guanidine is comprised of ≥2 rings (e.g., structures (IV) and (V)), the number of members in each ring of the cyclic guanidine can either be the same or different. For example, one ring may be a 5-member ring while the other ring may be a 6-member ring. If the cyclic guanidine is comprised of ≥3 rings, then in addition to the combinations cited in the preceding sentence, the number of members in a first ring of the cyclic guanidine may be different from the number of members in any other ring of the cyclic guanidine.

It will also be understood that the nitrogen atoms of structures (II)-(V) may further comprise additional atoms attached thereto. Moreover, the cyclic guanidine may either be substituted or unsubstituted. For example, as used herein in conjunction with the cyclic guanidine, the term “substituted” refers to a cyclic guanidine wherein R5, R6, and/or R7 of structures (II) and/or (III) and/or R9 of structures (IV) and/or (V) is not hydrogen. As used herein in conjunction with the cyclic guanidine, the term “unsubstituted” refers to a cyclic guanidine wherein R1-R7 of structures (II) and/or (III) and/or R1-R9 of structures (IV) and/or (V) are hydrogen.

The cyclic guanidine may comprise a bicyclic guanidine, and the bicyclic guanidine may comprise 1,5,7-triazabicyclo[4.4.0]dec-5-ene (“TBD” or “BCG”) or 7-methyl-1,5,7-triazabicyclo[4.4.0]dec-5-ene (MTBD).

Other useful latent accelerators may comprise amidoamine or polyamide catalysts, such as, for example, one of the Ancamide® products available from Air Products, amine, dihydrazide, imidazole, or dicyandiamide adducts and complexes, such as, for example, one of the Ajicure® products available from Ajinomoto Fine Techno Company, 3,4-dichlorophenyl-N,N-dimethylurea (A.K.A. Diuron) available from Alz Chem, or combinations thereof.

Useful imidazoles comprise, as examples, the following: imidazole, 1-methylimidiazole, 1,2-dimethyl imidazole, 2-ethyl-4-methylimidazole, 2-heptaecylimidazole (Curezol® C17Z from Evonik Corporation) and N,N′-cabonyldiimidazole (CDI).

The adhesive composition of the present disclosure optionally may further comprise elastomeric particles that are separate from the plurality of particles component of the adhesive composition described above that comprise an exterior surface comprising a coating deposited thereon wherein the coating comprises an aminoplast resin. Useful elastomeric particles comprise those described above, including elastomeric particles having a core-shell structure. For example, the elastomeric particles may optionally be introduced into the curing agent or accelerator of the adhesive composition as solid particles, such as core-shell elastomeric particles comprising an average particle size of 20 nm to 400 nm.

The adhesive composition and/or the epoxy component may comprise the elastomeric particles in an amount of at least 1 percent by weight based on total weight of the composition, such as at least 3 percent by weight, such as at least 5 percent by weight, and the adhesive composition and/or the epoxy component may comprise the elastomeric particle in an amount of amount of no more than 50 percent by weight based on total weight of the composition, such as no more than 40 percent by weight, such as no more than 25 percent by weight. The epoxy component and/or the curing agent may comprise the elastomeric particles, in an amount of 1 percent by weight to 50 percent by weight based on total weight of the composition, such as 3 percent by weight to 40 percent by weight, such as 5 percent by weight to 25 percent by weight.

Another example of an adhesive compound that may be combined with the coated particles is a polyurethane or a polyurea. A polyurethane or polyurea adhesive compound may be a 1K or 2K adhesive compounds. Polyurethane polymers comprising terminal isocyanate or hydroxyl groups are prepared by reacting polyols including polymeric polyols with polyisocyanates. Polyureas comprising terminal isocyanate or primary and/or secondary amine groups are prepared by reacting polyamines including polymeric polyamines with polyisocyanates. The hydroxyl/isocyanate or amine/isocyanate equivalent ratio is adjusted, and reaction conditions are selected to obtain the desired terminal groups.

An organic polyisocyanate that may be used in an adhesive compound can comprise an aliphatic or an aromatic polyisocyanate or mixture of the two. Polyisocyanates include diisocyanates and higher polyisocyanates. Polyisocyanates can be used alone or in combination with other polyisocyanates and/or monoisocyanates. Examples of suitable monoisocyanates comprise cyclohexyl isocyanate, phenyl isocyanate and toluene isocyanate. Examples of diisocyanates for use in the disclosure may comprise but are not limited to isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H₁₂MDI, available as DESMODUR W from Bayer Corporation of Pittsburgh, Pennsylvania); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof. Also, cycloaliphatic diisocyanates such as 1,4-cyclohexyl diisocyanate, isophorone diisocyanate, alpha, alpha-xylylene diisocyanate and 4,4′-methylene-bis(cyclohexyl isocyanate) may be utilized. Non-limiting examples of suitable aromatic diisocyanates may comprise but are not limited to phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, alkylated benzene diisocyanates, methylene-interrupted aromatic diisocyanates such as methylenediphenyl diisocyanate, 4,4′-isomer (MDI) including alkylated analogs such as 3,3′-dimethyl-4,4′-diphenylmethane diisocyanate, polymeric methylenediphenyl diisocyanate; and mixtures thereof.

Examples of suitable higher polyisocyanates are 1,2,4-benzene triisocyanate and polymethylene polyphenyl isocyanate. Examples of suitable higher polyisocyanates are 1,2,4-benzene triisocyanate and polymethylene polyphenyl isocyanate. Examples of suitable monoisocyanates are cyclohexyl isocyanate, phenyl isocyanate and toluene isocyanate. Substituted organic polyisocyanates can also be used in which the substituents are nitro, chloro, alkoxy and other groups which are not reactive with hydroxyl groups or active hydrogens and provided the substituents are not positioned to render the isocyanate group unreactive. Examples include chloro or alkoxy (e.g., methoxy) substituted diphenyl diisocyanates.

In other non-limiting examples of the present disclosure, the isocyanate can comprise an oligomeric isocyanate such as but not limited to dimers such as the uretdione of 1,6-hexamethylene diisocyanate, trimers such as the biuret and isocyanurate of 1,6-hexanediisocyanate and the isocyanurate of isophorone diisocyanate, allophonates and polymeric oligomers. Modified isocyanates can also be used, including but not limited to carbodiimides and uretone-imines, and mixtures thereof. Suitable materials include, without limitation, those available under the designation DESMODUR from Bayer Corporation of Pittsburgh, PA and include DESMODUR N 3200, DESMODUR N 3300, DESMODUR N 3400, DESMODUR XP 2410, DESMODUR XP 2580 and DESMODUR VK5 that is a mixture of diphenylmethane-4,4′-diisocyanate (MDI) with isomers and higher functional homologues (PMDI).

There can also be employed isocyanate-terminated adducts of diols or polyols such as ethylene glycol, 1,4-butylene glycol, polyalkylene glycol and the like. These are formed by reacting more than one equivalent of the diisocyanate, such as those mentioned with one equivalent of diol or polyalcohol to form a diisocyanate product.

Any suitable organic compound containing active hydrogens may be used for reaction with the organic polyisocyanate to form a partially reacted NCO-containing polymer. Highly active hydrogens include hydrogen atoms attached to oxygen or nitrogen and useful compounds will comprise those having at least two of these groups comprising hydroxyl groups and primary and secondary amine groups. The moieties attached to each group can be aliphatic, aromatic, cycloaliphatic or of a mixed type.

Examples of such compounds comprise amines, which comprises polyamines, aminoalcohols, mercapto-terminated derivatives, and alcohols, which comprises polyhydroxy materials (polyols) which are preferred because of the case of reaction they exhibit with polysiocyanates. Alcohols and amines generally give no side reactions, giving higher yields of urethane (or urea) product with no by-product and the products are hydrolytically stable. Also, with regard to polyols, there are a wide variety of materials available which can be selected to give a wide spectrum of desired properties. In addition, the polyols have desirable reaction rates with polyisocyanates. Both saturated and unsaturated active hydrogen-containing compounds can be used.

The amines which can be employed in the preparation of the urethanes of the disclosure can comprise primary or secondary diamines or polyamines in which the radicals attached to the nitrogen atoms can be saturated or unsaturated, aliphatic, alicyclic, aromatic, aromatic-substituted aliphatic, aliphatic-substituted aromatic or heterocyclic. Mixed amines in which the radicals are different such as, for example, aromatic and aliphatic can be employed and other non-reactive groups can be present attached to the carbon atom, such as oxygen, sulfur, halogen or nitroso. Exemplary of suitable aliphatic and alicyclic diamines comprise the following: 1,2-ethylene diamine, 1,2-propylene diamine, 1,8-menthane diamine, isophorone diamine, propane-2,2-cyclohexyl amine and methane-bis-(4-cyclohexyl amine). Representative polyamines also include but are not limited to polyether functional polyamine; i.e., polyoxyalkyleneamines, comprising two or more primary or secondary amino groups attached to a backbone, derived, for example, from propylene oxide, ethylene oxide, butylene oxide or a mixture thereof. Examples of such amines include those available under the designation JEFFAMINE®, such as JEFFAMINE® D230, D-2000 and D-4000 commercially available from the Huntsman Corporation). Such amines comprise an approximate molecular weight ranging from 200 to 5000 g/mol.

Aromatic diamines such as the phenylene diamines and the toluene diamines can be employed. Exemplary of the aforesaid amines are o-phenylene diamine and p-tolylene diamine. N-alkyl and N-aryl derivatives of the above amines can be employed such as, for example, N,N′-dimethyl-o-phenylene diamine, N,N′-di-p-tolyl-m-phenylene diamine, and p-amino-diphenylamine.

Polynuclear aromatic diamines can be employed in which the aromatic rings are attached by means of a valence bond such as, for example, 4,4′-biphenyl diamine, methylene dianiline and monochloromethylene dianiline.

The use of amines dissolved in ketones is sometimes desirable because of better control over reaction conditions.

Besides or in addition to the amines mentioned above, hydrazines and hydrazides can also be employed.

Aminoalcohols, mercapto-terminated derivatives and mixtures, and the like, hydroxy acids and amino acids can also be employed as the active hydrogen compounds. Examples are: monoethanolamine, 4-amino-benzoic acid, aminopropionic acid, N-(hydroxyethyl)ethylene diamine, 4-hydroxybenzoic acid, p-aminophenol, dimethylol propionic acid, hydroxy stearic acid, and beta-hydroxypropionic acid. When amino acids are used, additional basic material should also be present to release NCO-reactive amines from Zwitterion complexes.

The polyhydroxyl materials or polyols can comprise either low or high molecular weight materials and in general will have average hydroxyl values as determined by ASTM designation E-222-67, Method B, between about 1000 and 10, and preferably between about 500 and 50. The term “polyol” is meant to comprise materials having an average of two or more hydroxyl groups per molecule.

The polyols can comprise low molecular weight diols, triols and tetraols and higher functional polyols, low molecular weight amide-containing polyols and higher polymeric polyols such as polyester polyols, polyether polyols and hydroxy-containing acrylic interpolymers. Suitable polyols also can comprise but are not limited to those referenced above to form an epoxy-adduct. Examples of higher molecular weight polyglycols can comprise but are not limited to polyethylene glycol, polypropylene glycol, polytetramethylene glycol, and the like.

Low molecular weight diols, triols and higher alcohols useful in the instant disclosure may comprise hydroxy values of 200 or above, usually within the range of 1500 to 200. Such materials include aliphatic polyols, particularly alkylene polyols containing from 2 to 18 carbon atoms. Examples include ethylene glycol, 1,2-propylene glycol, 1,3-butylene glycol, tetramethylene glycol, hexamethylene glycol, 1,4-butanediol, 1,6-hexanediol; cycloaliphatic polyols such as 1,2-cyclohexanediol and cyclohexane dimethanol. Examples of triols and higher alcohols include trimethylol propane, glycerol and pentaerythritol. Also useful are polyols containing either linkages such as diethylene glycol and triethylene glycol and oxyalkylated glycerol.

Also useful are low molecular weight amide-containing polyols comprising hydroxyl values of 100 or above. These materials are described in U.S. Pat. No. 3,959,201 assigned to PPG Industries, Inc. Examples can comprise polyurethane polyol oligomers, cyclic nitrogen compounds, polyurea polyol oligomers and polyamide polyol oligomers. When these low molecular weight amide-containing polyols are incorporated into the polymer, they may enhance a water dispersibility of the polymer.

Also useful are polyether polyols formed from the oxyalkylation of various polyols, for example, glycols such as ethylene glycol, 1,6-hexanediol, Bisphenol A, and the like, or higher polyols, such as trimethylol propane, pentaerythritol and the like. Polyols of higher functionality which can be utilized as indicated can be made, for instance, by oxyalkylation of compounds as sorbitol or sucrose. One commonly utilized oxyalkylation method is by reacting a polyol with an alkylene oxide, for example, ethylene or propylene oxide, in the presence of an acidic or basic catalyst.

Polyester polyols can also be used as a polymeric polyol component in the practice of the disclosure. The polyester polyols can be prepared by the polyesterification of organic polycarboxylic acids or anhydrides thereof with organic polyols. Usually, the polycarboxylic acids and polyols are aliphatic or aromatic dibasic acids and diols.

The polyols which are usually employed in making the polyester polyols can comprise alkylene glycols, such as ethylene glycol and butylene glycol, neopentyl glycol and other glycols such as hydrogenated Bisphenol A, cyclohexane diol, cyclohexane dimethanol, caprolactone diol (for example, the reaction product of caprolactone and ethylene glycol), hydroxy-alkylated bisphenols, polyether glycols, for example, poly(oxytetramethylene)glycol and the like. However, other diols of various types and, as indicated, polyols of higher functionality can also be utilized. Such higher polyols can comprise, for example, trimethylol propane, trimethylol ethane, pentaerythritol, and the like, as well as higher molecular weight polyols such as those produced by oxyalkylating low molecular weight polyols. An example of such high molecular weight polyol is the reaction product of 20 moles of ethylene oxide per mole of trimethylol propane.

Carboxylic acid group-containing polyols can also be used. Examples of carboxylic acid group-containing polyols can comprise but are not limited to 2,2-dimethylol propionic acid, 2,2-dimethylol butyric acid, 2,2-dimethylol valeric acid, and the like.

The proportions of the hydroxyl group-containing reactants may be changed variously but the equivalent ratio between isocyanate groups and hydroxyl groups in all components can comprise from 1.0:0.75 to 1.0:1.5 such as 1.0:1.0 to 1.0:1.3.

A polyurethane adhesive compound may comprise one or more elastomeric segment(s). The term “elastomeric segment”, with respect to a polymer, refers to a section or sections on the backbone of a polymer that imparts a degree of elasticity, and which helps provide the elastomeric properties in a coating formed from an adhesive compound containing the polymer such as when a coating formed from an adhesive compound containing the polymer is applied on or over a substrate. “Elastomeric” and like terms as used herein refer to materials that impart elasticity. “Elasticity” and like terms refer to the ability of a material to return to its approximate original shape or volume after the material has been deformed, such as for example stretched. An example of a material that can be used for an elastomeric segment(s) in a polyurethane adhesive compound comprise rubber-based polymers. Non-limiting examples of rubber-based polymers can comprise cis-1,4-polyisoprene rubber, styrene/butadiene copolymers, polybutadiene rubber including, for example, hydroxyl-terminated polybutadiene (Poly BD® R45 HT LO), styrene/isoprene/butadiene rubber, butyl rubber, halobutyl rubber, and combinations thereof.

In order to accelerate the reaction to form a polyurethane polymer, there may be used accelerators generally used in the conventional urethane reactions, such as triethylamine, N-ethyl morpholine, triethyldiamine, 1,2-dimethylimidazole and the like, as well as tin type catalysts such as dibutyl tin dilaurate, dioctyl tin dilaurate and the like. The amounts in which these catalysts are suitably used in the process of the present disclosure depend on the type of catalyst and typically range from 0.01 to 5 percent by weight (wt %) of the adhesive compound, such as 0.05 to 1 wt %, such as 0.1 to 0.5 wt % and such as 0.19 to 0.44 wt %.

A polyurethane adhesive compound may also optionally comprise a plasticizer. A plasticizer may serve to increase a flexibility or workability of a polymer system. Examples of plasticizers that may be used can comprise but are not limited to diisononyl dihthalate (DINP) (Jayflex™ DINP available from ExxonMobile Chemical); dioctyl terephthalate (DOTP) (Eastman 168 available from Eastman Chemical Company); dibutyl terephthalate (DBT) (available from Eastman Chemical Company); diproyleneglycol dibenzoate (K-FLEX®-DP available from Kalama); Cyclohexanedicarboxylic acid, dinonyl ester (DINCH) (HEXAMOLL® DINCH available from BASF); Dioctylterephthalate (Eastman 168); epoxidized soybean oil (ESO) (PLASTHALL® ESO available from Hallstar); Trioctyl trimellitate (TOTM) (available from Eastman); and polybutadiene (POLYVEST® 100 available from Evonik). An amount of a plasticizer, if included in an adhesive compound, may range from 2 to 50 wt %, such as 3 to 40 wt %, such as 5 to 40 wt % and such as 10 to 35 wt %.

For a 2K adhesive compound, a diisocyanate may be reacted with a part of the polyol and part of the functionalized rubber-based polymer to synthesize a prepolymer having the isocyanate end (Part A), and thereafter the remainder of the polyol and a functionalized rubber-based polymer (Part B) are reacted with the prepolymer. Generally, the reaction may be carried out at the temperature of 40° C. to 180° C., such as 60° C. to 130° C. In forming an adhesive composition of the disclosure, the aminoplast-coated particles and other optional fillers or other additives may be added to one or both of Part A and Part B (e.g., divided among Part A and Part B).

According to the disclosure, an adhesive composition may comprise an adhesive compound (e.g., an epoxy, a polyurethane) combined with (e.g., mixed with) a plurality of particles each comprising an exterior surface comprising a coating deposited thereon, wherein the coating may comprise a thermoset material. The aminoplast resin-coated particles may be characterized as a filler. The use of lightweight particles allows the aminoplast resin-coated particles in an adhesive composition to reduce the density of the adhesive composition without sacrificing performance.

The adhesive compositions disclosed herein, specifically, adhesive compositions comprising an adhesive compound and a plurality of coated particles, unexpectedly (i) comprise a density that is at least 10 percent lower than adhesive compositions that comprise conventional fillers but not the plurality of coated particles disclosed herein, while also (ii) maintaining mechanical properties of the adhesive formed from the adhesive compositions in at least partially cured state. For example, (i) the density of such adhesive compositions may be at least 20 percent lower than adhesive compositions that comprise conventional fillers but not the plurality of coated particles disclosed herein, such as at least 30 percent lower, such as at least 40 percent lower, such as at least 50 percent lower, (ii) the structural adhesive formed from such adhesive composition, in an at least partially cured state, comprises a resistance to cleavage fracture or wedge impact at 25° C. of greater than 10 Newtons per millimeter (N/mm) and a resistance to cleavage fracture or wedge impact at −40° C. of greater than 3 N/mm measured according to ISO 11343 on 0.75 mm thick cold rolled steel (CRS), and/or (iii) the semi-structural adhesive formed from such adhesive compositions, in an at least partially cured state, comprises a resistance to cleavage fracture or wedge impact at 25° C. of greater than 3 N/mm measured according to ISO 11343 on 0.75 mm thick cold rolled steel (CRS).

As described in more detail below, the adhesive compositions that form a structural adhesive may comprise (i) a density of less than 1.1 pounds/gal measured according to ASTM D5965, such as less than 1 pounds/gal, such as less than 0.9 pounds/gal, such as less than 0.8 pounds/gal, such a greater than 0.05 pounds/gal, and may, in at least partially cured state, and may form an adhesive comprising (ii) a resistance to cleavage fracture or wedge impact at 25° C. of greater than 14 N/mm measured according to ISO 11343 on 0.75 mm thick cold rolled steel (CRS), such as greater than 16 N/mm, such as greater than 18 N/mm, such as greater than 20 N/mm, such as greater than 22 N/mm, such as no more than 40 N/mm, such as 14 N/mm to 40 N/mm, such as 16 N/mm to 40 N/mm, such as 18 N/mm to 40 N/mm, such as 20 N/mm to 40 N/mm, such as 22 N/mm to 40 N/mm, and/or (iii) a resistance to cleavage fracture or wedge impact at −40° C. of greater than 3 N/mm measured according to ISO 11343 on 0.75 mm thick cold rolled steel (CRS), such as greater than 4 N/mm, such as greater than 5 N/mm, such as greater than 6 N/mm, such as greater than 7 N/mm, such as greater than 8 N/mm, such as greater than 9 N/mm, such as greater than 10 N/mm, such as no more than 25 N/mm, such as 7 N/mm to 25 N/mm, such as 8 N/mm to 25 N/mm, such as 9 N/mm to 25 N/mm, such as 10 N/mm to 25 N/mm, and/or (iv) a relative peel resistance or T-Peel of greater than 2 N/mm measured according to ASTM D1876 on 0.79 mm thick hot dip galvanized (HDG) steel, such as greater than 4 N/mm, such as greater than 6 N/mm, such as greater than 8 N/mm, such as greater than 10 N/mm, such as no more than 20 N/mm, such as 2 N/mm to 20 N/mm, such as 4 N/mm to 20 N/mm, such as 6 N/mm to 20 N/mm, such as 8 N/mm to 20 N/mm, such as 10 N/mm to 20 N/mm. Such structural adhesive compositions may comprise a 1K composition.

As described in more detail below, the adhesive compositions that form a semi-structural adhesive may comprise a density of less than 6 pounds/gal measured according to ASTM D5965 and may, in at least partially cured state, form an adhesive comprising a resistance to cleavage fracture or wedge impact at 25° C. of greater than 3 N/mm measured according to ISO 11343 on 0.75 mm thick cold rolled steel (CRS) and/or a relative peel resistance or T-Peel of greater than 0.5 N/mm measured according to ASTM D1876 on 0.79 mm thick hot dip galvanized (HDG) steel.

As described in more detail below, the adhesive compositions that form a structural adhesive may comprise (i) a density of less than 6 pounds/gal measured according to ASTM D5965, such as less than 5 pounds/gal, such as less than 4 pounds/gal, such as less than 3 pounds/gal, such a greater than 0.05 pounds/gal, and may, in at least partially cured state, and may form an adhesive comprising (ii) a resistance to cleavage fracture or wedge impact at 25° C. of greater than 3 N/mm measured according to ISO 11343 on 0.75 mm thick cold rolled steel (CRS), such as greater than 4 N/mm, such as greater than 5 N/mm, such as greater than 10 N/mm, such as no more than 20 N/mm, such as 4 N/mm to 20 N/mm, such as 5 N/mm to 20 N/mm, such as 10 N/mm to 20 N/mm, and/or (iv) a relative peel resistance or T-Peel of greater than 0.5 N/mm measured according to ASTM D1876 on 0.79 mm thick hot dip galvanized (HDG) steel, such as greater than 0.75 N/mm, such as greater than 1 N/mm, such as greater than 2 N/mm, such as no more than 3 N/mm, such as 0.5 N/mm to 3 N/mm, such as 0.75 N/mm to 3 N/mm, such as 1 N/mm to 3 N/mm, such as 2 N/mm to 3 N/mm. Such structural adhesive compositions may comprise a 2K composition.

The adhesive composition may comprise a 1K adhesive composition such that the adhesive compound, the plurality of coated particles and any optional ingredients are premixed and stored and react upon activation by an external energy source.

The adhesive composition of the disclosure may comprise a 2K adhesive composition that may comprise (a) a first component and (b) a second component which are mixed just prior to application. The curing between the first component (a) and the second component (b) to form a crosslinked final product occurs immediately upon mixing at ambient or slightly thermal temperatures (e.g., without the need for an external energy source such as an oven or actinic radiation source). The first component and/or the second component may comprise the plurality of coated particles. Optionally, a third component or higher may comprise the plurality of coated particles.

The adhesive composition can comprise the adhesive compound in an amount of at least 85 percent by weight based on total weight of the adhesive composition, such as at least 90 percent by weight, such as at least 93 percent by weight. The adhesive composition can comprise the adhesive compound in an amount of no more than 99.95 percent by weight based on total weight of the adhesive composition, such as no more than 99.9 percent by weight, such as no more than 99.8 percent by weight. The adhesive composition may comprise the adhesive compound in an amount of 85 percent by weight to 99.95 percent by weight based on total weight of the adhesive composition, such as 90 percent by weight to 99.9 percent by weight, such as 93 percent by weight to 99.8 percent by weight.

As noted, in addition to the thermoset resin-coated particles, an adhesive composition may optionally comprise other fillers. Useful fillers that may be introduced to the adhesive composition include organic and/or inorganic fillers that may have a specific gravity of at least 1.5 when measured according to ASTM D5965, such as at least 3, such as at least 5, such as at least 10, such as at least 20. Useful fillers that may be introduced to the adhesive composition include organic and/or inorganic fillers that may have a specific gravity of 1.5 to 20, such as 1.5 to 10, such as 1.5 to 5 when measured according to ASTM D5965. Useful organic fillers that may be introduced can comprise cellulose, starch, and acrylic. Useful inorganic fillers that may be introduced can comprise borosilicate, aluminosilicate, calcium inosilicate (Wollastonite), mica, silica and calcium carbonate. The organic and inorganic fillers may be solid, hollow, or layered in composition and may range in size from 10 nm to 1 mm in at least one dimension. Useful fillers may comprise any of the particles described above that were used to form the described aminoplast resin-coated particles. Such particles may be included as fillers without the aminoplast resin coating so that an adhesive composition comprises a plurality of lightweight particles comprising an exterior surface coated with an aminoplast resin as well as a plurality of particles (fillers) without an exterior surface coated with an aminoplast resin. Suitable lightweight particles for use as fillers can comprise solid and hollow particles, lightweight particles such as microspheres and amorphous particles as described as well as the described thermally expandable capsules that may or may not comprise a volatile hydrocarbon positioned within a wall of a resin, such as a thermoplastic resin. Examples of thermally expandable capsules suitable for use in the present disclosure are commercially available from various companies, specific examples of which include Union Carbide Corporations Ucar and Phenolic Microballoons (phenol balloons), Emerson & Cuming Company's Eccospheres (epoxy balloons), Emerson & Cuming Company's Eccospheres VF-O (urea balloons), Dow Chemical Company's Saran Microspheres, AKZO NOBEL's Expancel and Matsumoto Yushi Seiyaku Co., Ltd.'s Matsumoto Microspheres (Saran balloons), Arco Polymers Inc.'s Dylite Expandable Polystyrene and BASF-Wyandotte's Expandable Polystyrene Beads (polystyrene balloons), and JSR Corporation's SX863 (P) (crosslinked styrene-acrylic balloons).

The fillers used in the present disclosure can comprise a lamellar structure. Particles comprising a lamellar structure are composed of sheets or plates of atoms, with strong bonding within the sheet and weak van der Waals bonding between sheets, providing low shear strength between sheets. A non-limiting example of a lamellar structure comprises a hexagonal crystal structure. Inorganic solid particles comprising a lamellar fullerene (i.e., buckyball) structure are also useful in the present disclosure.

Non-limiting examples of suitable materials comprising a lamellar structure can comprise boron nitride, graphite, metal dichalcogenides, mica, talc, gypsum, kaolinite, calcite, cadmium iodide, silver sulfide and mixtures thereof. Suitable metal dichalcogenides include molybdenum disulfide, molybdenum diselenide, tantalum disulfide, tantalum diselenide, tungsten disulfide, tungsten diselenide and mixtures thereof.

Optionally, according to the disclosure, additional fillers, thixotropes, colorants, tints and/or other materials also may be added to the adhesive composition.

Useful thixotropes that may be used can comprise untreated fumed silica and treated fumed silica, castor wax, clay, organo clay and combinations thereof. In addition, fibers such as synthetic fibers like Aramid® fiber and Kevlar® fiber, acrylic fibers, and/or engineered cellulose fiber may also be utilized.

Useful fillers that may be used in conjunction with thixotropes may comprise inorganic fillers such as inorganic clay or silica and combinations thereof.

Exemplary other materials that may be utilized as fillers can comprise, for example, calcium oxide and carbon black and combinations thereof.

The adhesive composition can comprise fillers other than the coated particles in an amount of no more than 10 percent by weight based on total weight of the adhesive composition, such as no more than 8 percent by weight, such as no more than 6 percent by weight. The adhesive composition can comprise fillers in an amount of up to 10 percent by weight based on total weight of the adhesive composition, such as 0.1 percent by weight to 10 percent by weight, such as 0.1 percent by weight to 8 percent by weight, such as 0.1 percent by weight to 6 percent by weight.

Colorants, dyes, or tints such as red iron pigment, titanium dioxide, calcium carbonate, and phthalocyanine blue and combinations thereof may be included as fillers in the adhesive composition.

Optionally, the adhesive composition may be substantially free, or essentially free, or completely free, of platy fillers such as talc, pyrophyllite, chlorite, vermiculite, or combinations thereof.

The adhesive composition may further comprise an additive or more than one additive. As used herein, the term “additive(s)” refers to ingredients or components included in the adhesive composition in addition to the adhesive compound, the accelerator (if any), the curing agent (if any), the catalyst (if any), and the fillers (if any) described herein. Exemplary non-limiting examples of such additives include flexibilizers such as Flexibilizer DY 965 from Huntsman Corporation, reactive liquid rubber, non-reactive liquid rubber, epoxy-amine adducts (such as those described above but, when present, different from the epoxy-containing compound present in the adhesive composition), epoxy-thiol adducts, blocked isocyanates, capped isocyanates, epoxy-urethanes, epoxy-ureas, modified epoxies from Hexion, HELOXY™ modifiers from Hexion, adhesion promoters, silane coupling agents such as Silquest A-187 from Momentive, flame retardants, colloidal silica such as NANOPOX® dispersions from Evonik, thermoplastic resins, acrylic polymer beads such as ZEFIAC® beads from AICA Kogyo Co, cyclic carbonate, or combinations thereof.

The composition may further comprise a cyclic carbonate-functional molecule. The cyclic carbonate-functional molecule may be present in the first component and/or the second component. Useful examples of cyclic carbonate-functional molecules include glycerol carbonate, propylene carbonate, and combinations thereof. The cyclic carbonate-functional molecule may be present in the epoxy component or may be pre-reacted with the diamine or polyamine containing a cyclic ring. In an example, the curing agent may comprise the reaction product of excess xylylene diamine with glycerol carbonate having the following structure:

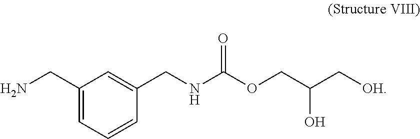 [SMILES: NCc1cccc(CNC(=O)OCC(O)CO)c1]

The adhesive composition can comprise the cyclic carbonate-functional molecule in an amount of at least 0.1 percent by weight based on total weight of the composition, such as at least 1 percent by weight, such as at least 2 percent by weight, and may be present in an amount of no more than 10 percent by weight, such as no more than 8 percent by weight, such as no more than 6 percent by weight. The adhesive composition can comprise the cyclic carbonate-functional molecule in an amount of up to 10 percent by weight based on total weight of the composition, such as 0.1 percent by weight to 10 percent by weight, such as 1 percent by weight to 8 percent by weight, such as 2 percent by weight to 6 percent by weight.

An adhesive composition that is a structural adhesive composition may comprise a measured Tg of greater than 40° C., such as greater than 100° C., such as greater than 150° C., such as greater than 200° C. Tg values as used herein with respect to the adhesive composition of the present disclosure means the peak in the tan delta curve generated by Dynamic Mechanical Analysis (DMA) test using a strain of 0.01 percent, a frequency of 6.28 Rad/s, and a temperature ramp of 2° C./minute using a TA Instruments RSA3 Dynamic Mechanical Analyzer or other similar equipment. A semi-structural adhesive composition or a flexible adhesive composition may comprise a measured Tg of −100° C. to 40° C., such as −60° C. to 20° C. or such as −50° C. to 0° C.

The present disclosure also is directed to a method for treating a substrate comprising, or consisting essentially of, or consisting of, contacting at least a portion of a surface of the substrate with one of the adhesive compositions of the disclosure described hereinabove. The adhesive composition may be at least partially cured to form a coating, layer or film on the substrate surface by exposure to an external energy source, as described herein.

The present disclosure is also directed to a method for forming a bond between two substrates for a wide variety of potential applications in which the bond between the substrates provides particular mechanical properties related to both wedge impact and T-peel resistance. The method may comprise, or consist essentially of, or consist of, applying one of the adhesive compositions described above to a first substrate; contacting a second substrate to the composition such that the composition is located between the first substrate and the second substrate; and at least partially curing the composition by exposure to an external energy source, as described herein. For example, the adhesive composition may be applied to either one or both of the substrate materials being bonded to form an adhesive bond therebetween and the substrates may be aligned, and pressure and/or spacers may be added to control bond thickness. The composition may be applied to cleaned or uncleaned (i.e., including oily or oiled) substrate surfaces. It may also be applied to a substrate that has been pretreated, coated with an electrodepositable coating, coated with additional layers such as a primer, basecoat, or topcoat. An external energy source may subsequently be applied to cure the adhesive composition, such as baking in an oven.

As stated above, the adhesive compositions of the present disclosure may form a structural adhesive on a substrate or a substrate surface. The adhesive composition may be applied to substrate surfaces, including, by way of non-limiting example, a vehicle body, components of an automobile frame or an airplane, parts used in or on a vehicle, or to armor assemblies such as those on a tank, and the like.

The adhesive composition described above may be applied alone or as part of a coating system that can be deposited in a number of different ways onto a number of different substrates, non-limiting examples of which include brushes, rollers, films, pellets, pressure injectors, spray guns and applicator guns. The system may comprise a number of the same or different layers and may further comprise other coating compositions such as pretreatment compositions, primers, and the like. A coating, film, layer or the like is typically formed when an adhesive composition that is deposited onto the substrate is at least partially cured by methods known to those of ordinary skill in the art (e.g., under ambient conditions and/or by exposure to thermal heating or actinic radiation) to form a coating, layer or film. A 2K adhesive composition may at least partially cure at ambient temperature and 1K adhesive compositions may at least partially cure at greater than ambient temperature, such as through the use of an external energy source such as an oven or other thermal means or through the use of actinic radiation. For example, a 1K adhesive composition may cured by baking and/or curing at a temperature of at least 80° C., such as at a temperature of at least 130° C., such as at least 140° C., such as at least 150° C., such as at least 170° C. for a period of time (e.g., 5 minutes to 24 hours) to achieve acceptable wedge impact and T-peel resistance. In other examples, a 1K adhesive composition can be cured by baking at a temperature of no more than 250° C., such as no more than 210° C., and in some cases at a temperature of from 80° C. to 250° C., such as from 150° C. to 210° C., and for any desired time period (e.g., from 5 minutes to 24 hours) sufficient to at least partially cure the adhesive composition on the substrate(s). The skilled person understands, however, that the time of curing varies with temperature.

Still further disclosed are substrates and articles comprising, or consisting essentially of, or consisting of, adhesives formed from the adhesive compositions of the present disclosure. For example, also disclosed is a coated substrate, wherein at least a portion of a surface of the substrate is at least partially coated with an adhesive composition comprising, or consisting essentially of, or consisting of an adhesive compound and a plurality of the coated particles described above. Also disclosed is an article comprising, or consisting essentially of, or consisting of, first and second substrates and an adhesive composition positioned therebetween and in an at least partially cured state.

The substrates that may be coated by the compositions of the present disclosure are not limited. Suitable substrates useful in the present disclosure include, but are not limited to, materials such as metals or metal alloys, ceramic materials such as boron carbide or silicon carbide, polymeric materials such as hard plastics including filled and unfilled thermoplastic materials or thermoset materials, or composite materials. Other suitable substrates useful in the present disclosure include, but are not limited to, glass or natural materials such as wood. For example, suitable substrates include rigid metal substrates such as ferrous metals, aluminum, aluminum alloys, magnesium titanium, copper, and other metal and alloy substrates. The ferrous metal substrates used in the practice of the present disclosure may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. Aluminum alloys of the 1XXX, 2XXX, 3XXX, 4XXX, 5XXX, 6XXX, 7XXX, or 8XXX series as well as clad aluminum alloys and cast aluminum alloys of the A356, 1XX.X. 2XX.X, 3XX.X. 4XX.X. 5XX.X, 6XX.X. 7XX.X, or 8XX.X series also may be used as the substrate. Magnesium alloys of the AZ31B, AZ91C, AM60B, or EV31A series also may be used as the substrate. The substrate used in the present disclosure may also comprise titanium and/or titanium alloys of grades 1-36 including H grade variants. Other suitable non-ferrous metals include copper and magnesium, as well as alloys of these materials. Suitable metal substrates for use in the present disclosure include those that are used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, and industrial structures and components. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091. The substrate may comprise a composite material such as a plastic or a fiberglass composite. The substrate may be a fiberglass and/or carbon fiber composite. The compositions of the present disclosure are particularly suitable for use in various industrial or transportation applications including automotive, light and heavy commercial vehicles, marine, or aerospace. The first and second substrates may be made of the same material or may be made of dissimilar materials. For example, a first substrate and a second substrate may be a metal and a plastic; two dissimilar plastics; a metal or a plastic and a reinforced plastic composite; or two dissimilar plastic composites.

### EXAMPLES

### Example 1: Synthesis of Polycaprolactone Diol Modified Epoxy Resin

948 grams (g) of methylhexahydrophthalic anhydride (“MHHPA”, commercially available from Dixie Chemical) and 4,054.7 g of Epon 828 (bisphenol A diglycidyl ether epoxy resin commercially available from Hexion Specialty Chemicals) were added to a 12-liter, 4-necked kettle equipped with a motor driven stainless steel stir blade, a water-cooled condenser, a nitrogen blanket, and a heating mantle with a thermometer connected through a temperature feedback control device. The contents of the kettle were heated to 90° C. and held for 30 minutes. 2.064.0 g of Capa 2077A (polycaprolactone-based diol commercially available from Perstorp Group) was added and the reaction mixture was held at 90° C. for 30 minutes. 395.9 g of Epon 828 and 46.4 g of triphenyl phosphine (available from Sigma Aldrich) were added and the mixture exothermed and was heated to 120° C. after exotherm. The reaction mixture was held at 120° C. until the acid value was less than 2 milligrams (mg) KOH/g by titration using a Metrohm 888 Titrando and 0.1 N KOH solution in Methanol as the titration reagent. The reaction temperature was cooled to 80° C. and the resin was poured out from the flask. The Epoxy equivalent of this epoxy adduct was 424 g/epoxide as determined by titration using a Metrohm 888 Titrando and 0.1 N Perchloric acid in glacial acetic acid. The weight average molecular weight was 3,670 g/mol as determined by Gel Permeation Chromatography using a Waters 2695 separation module with a Waters 410 differential refractometer (RI detector) and polystyrene standards. Tetrahydrofuran (THF) was used as the eluent at a flow rate of 1 milliliter per min (ml/min), and two PL Gel Mixed C columns were used for separation. The epoxy adduct prepared by this procedure is referred to as CAPA di-/MHHPA/Epon 828 in the following examples.

### Example 2: Synthesis of Polycaprolactone Tetraol Modified Epoxy Resin

1.038.6 g of MHHPA and 4,439.3 g of Epon 828 were added to a 12-liter, 4-necked kettle equipped with a motor driven stainless steel stir blade, a water-cooled condenser, a nitrogen blanket, and a heating mantle with a thermometer connected through a temperature feedback control device. The contents of the kettle were heated to 90° C. and held for 30 minutes. 1,589.1 g of Capa 4101 (polycaprolactone-based tetraol commercially available from Perstorp Group) was added and the reaction mixture was held at 90° C. for 30 minutes. 433.5 g of Epon 828 and 43.6 g of triphenylphosphine were added and the mixture exothermed and was heated to 120° C. after exotherm. The reaction mixture was held at 120° C. until the acid value was less than 2 milligrams (mg) KOH/g as determined by titration according to the procedure described above. The reaction mixture was cooled to 80° C. and the resin was poured out from kettle. The epoxy equivalent of this epoxy adduct was 412 g/epoxide as determined by titration according to the procedure described above. The weight average molecular weight was 18,741 g/mol as determined by the procedure described in Example 1. The epoxy adduct prepared by this procedure is referred to as CAPA tetra-/MHHPA/Epon 828 in the following examples.

### Example 3: Coated Particles

Adhesive compositions described below were prepared that included particles comprising a coated exterior surface (referenced as “coated particles”). The particles used were dry expanded thermoplastic hollow spheres commercially available as EXPANCEL 091 DE 80 d30 from Akzo Nobel. 6.0 grams of particles along with 551.8 grams de-ionized water and 22.4 grams of melamine formaldehyde (commercially available as CYMEL® 303 from Cytec Industries Inc.) were charged to a two-liter round bottom flask equipped with a stirrer and a heating mantle. With stirring, 22.4 grams of 10 percent para-toluene sulfuric acid (PTSA) in deionized water was added and the resultant mixture was warmed to 60° C. and held for two hours. Heat was removed and then 13 grams of saturated sodium bicarbonate was added. The mixture was then stirred for 10 minutes. The solids were filtered in a Buchner funnel, rinsed three times with clean water, and allowed to dry at ambient temperature overnight, then 24 hours at 49° C. The powder was then sifted through a 250-micron sieve. A size of particles measured by SEM was 29 microns+/−12 microns. A coating thickness measured by optical microscopy was 1.0 microns. The particles had a density of 0.51 pounds per gal (lbs/gal) measured according to ASTM D5965.

### Example 4: Adhesive Compositions

The adhesive compositions described below were prepared according to the following procedures with all non-manual mixing performed using a Speedmixer DAC 600FVZ (commercially available from FlackTeck, inc.). Both one component (1K) epoxy adhesive compositions and two component (2K) polyurethane adhesive compositions were prepared. For the one component epoxy adhesive compositions (Tables 1-3), the components included under “Resins” were combined and mixed for two minutes at 2,350 revolutions per minutes (“RPM”). After cooling to ambient temperature, the ingredients listed as “Catalysts and crosslinkers” and “Fillers” were then added and mixed for 25 seconds at 2,350 RPM. The mixture was examined with a spatula and mixed manually. As necessary, the mixing was repeated to ensure uniformity.

For the two-component polyurethane adhesive compositions (Table 4), the “Fillers” were dried for at least 24 hours in a vacuum oven (ambient temperature, −27.0 kPa) before use. Part A was prepared by combining each of the components listed under “Resins, diluents, and catalysts” in the order written. The materials were mixed on the DAC mixer for 10-15 seconds at 2350 rpm. The “Fillers” were then added, and the mixture was mixed for 10-45 seconds at 2350 rpm. The mixture was examined with a spatula and mixed manually. As necessary, the high-speed mixing was repeated to ensure uniformity. For part B, each component listed under “Resins and plasticizers” except the isocyanate component were added to a container separate from the part A in the order shown. The material was mixed for 10-15 seconds at 2350 rpm. The isocyanate component was then added, and the mixture mixed for 10-15 seconds at 2350 rpm. The “Fillers” were added, and the mixture was mixed for 10-45 seconds at 2350 rpm. The mixture was examined with a spatula and mixed manually. As necessary, the high-speed mixing was repeated to ensure uniformity. To apply the 2K adhesive composition, the part A and part B were mixed in a 1:1 weight ratio and used as quickly as possible (within 5 minutes).

For samples in Table 1-4, the substrates used were hot dip galvanized (HDG) steel panels (“coupons”) from ACT Test Panels LLC or cold rolled steel (CRS) according to the test method and specified in Table 2. Substrates were cleaned using an acetone wipe. A thin coating of oil (Quaker Ferrocote® 61A US) was evenly applied over the coupons in the bonding area. Then, the adhesive composition was applied to the oiled area on one of the coupons of the bond assembly. For the 1K epoxy adhesive compositions, uniformity of bond thickness was ensured by addition of 0.25 mm glass spacer beads. Spacer beads were sprinkled evenly over the material, covering no more than 5 percent of the total bond area. For the 2K polyurethane adhesive compositions, the spacer beads were mixed into the formulation (into part B). The oiled face of the other test coupon was placed on the bond area and spring-loaded clips were attached on to each side of the bond to hold the assembly together. Excess adhesive composition that squeezed out was removed with a spatula. Bond assemblies for the 1K epoxy adhesive compositions were baked at 145° C. for 30 minutes. Samples were conditioned for at least 16 hours at ambient condition before T-peel or wedge impact testing. For the 2K polyurethane adhesive compositions, bond assemblies were allowed to cure at ambient temperature for 42-48 hours before wedge impact or T-peel testing.

Coupons for T-peel testing were 0.79 mm×25 mm×100 mm hot dip galvanized (HDG) from ACT Test Panels LLC. At least three bonded assemblies were prepared for each adhesive composition and the average of the three (or more) is reported. The length of the bonded area was 87 mm and of the non-bonded area was 13 mm. Non-bonded portions were inserted in wedge action grips and pulled apart at a rate of 50 millimeters per minute (mm/min) using an Instron model 5567 in tensile mode. Peel strength was calculated as the steady state average load per width by Instron's Blue Hill software package. Except as noted, T-peel testing was performed according to ASTM D1876.

Coupons for wedge impact testing were 0.75 mm thick cold rolled steel (CRS) available from ACT Test Panels LLC. Coupons were cut and shaped according to the symmetric wedge specified in ISO 11343 standard. Three bonded assemblies were prepared for each adhesive composition and the average of the three is reported. Wedge impact testing was performed according to the ISO 11343 method (symmetric wedge configuration) on an Instron model CEAST 9350. The test was run with 50.6 J impact energy, 2.0 m/s impact velocity, and 204 mm falling height. Dynamic resistance to cleavage was calculated using Instron's Ceast View 6.45 software package. All samples were conditioned at the corresponding test temperature (ambient, 0° C., or −40° C.) for 30 minutes before testing.

In some instances, failure mode was measured. Cohesive failure mode was qualitatively determined by evaluating the bond after it has been subjected to a process that separates the substrate(s) bound by the adhesive bond, such as, for example, a T-peel test or wedge impact test. The cohesive failure mode of a bond was rated as either cohesive (pass) or adhesive (fail), wherein a fail indicates an interfacial failure of the bond and substrate leaving the adhesive on one substrate and the other substrate as bare metal or predominantly bare metal (i.e., one substrate has less than 90 percent adhesive surface coverage after the bonded substrates were pulled apart), and a pass indicates a failure within the adhesive bond leaving approximately equal thickness of adhesive on both substrates (i.e., both substrates have about >90% surface coverage with adhesive), as visually inspected.

Adhesive composition density was measured according to ASTM-01475-90.

The following examples shown in Tables 1-3 compare 1K epoxy adhesive compositions and in Table 4 compare 2K polyurethane adhesive compositions in accordance with certain examples of the present disclosure.

TABLE 1
Effect of lightweight coated filler on wedge impact, T-peel, and
adhesive density in the absence of conventional weight fillers.

| | Adhesive | Adhesive | Adhesive |
|---|---|---|---|
| | 1 (wt %) | 2 (wt %) | 3 (wt %) |
| Resins | | | |
| Kane Ace MX-153¹ | 67 | 67 | 67 |
| CAPA di-/MHHPA/Epon 828 | 12 | 12 | 12 |
| CAPA tetra-/MHHPA/Epon | 14 | 14 | 14 |
| 828 | | | |
| Fillers | | | |
| Mica DakotaPure 3000² | — | — | — |
| Calcium oxide³ | — | — | — |
| Wacker HDK H17⁴ | — | — | — |
| Coated particles⁵ | 0.35 | 0.70 | 1.4 |
| Curing agents | | | |
| Dicyandiamide⁶ | 4.8 | 4.7 | 4.7 |
| Diuron⁷ | 0.42 | 0.42 | 0.42 |
| Ajicure PN-50⁸ | 1.4 | 1.4 | 1.4 |
| CRS Wedge impact (N/mm) | 28.5 ± 0.2 | 21.7 ± 0.1 | 17.4 ± 0.6 |
| HDG T-peel (N/mm) | 3.7 ± 0.4 | 3.3 ± 0.4 | 5.4 ± 0.4 |
| Failure mode | adhesive | adhesive | Cohesive |
| Density (g/mL) | 0.99 | 0.99 | 0.88 |

¹33% Core shell rubber in unmodified, liquid epoxy resin based on Bisphenol-A available from Kaneka
²Potassium alumina silicate (mica) available from Pacer Corp.
³Calcium oxide available from Mississippi Lime, Co.
⁴Hydrophobic Fumed Silica available from Wacker Chemie AG
⁵Example 3
⁶Catalytically-active substituted urea available from Alz Chem
⁷3-(3,4-Dichlorophenyl)-1,1-dimethylurea available from Alz Chem
⁸Polymeric imidazole-based latent accelerator available from Ajinomoto Fine -Techno Co. Inc.

Table 1 presents three examples of one component epoxy adhesive compositions each having a different amount of coated lightweight particles as filler (0.35 weight percent, 0.70 weight percent and 1.4 weight percent, respectively). Table 1 shows that each composition (example compositions Adhesive 1, Adhesive 2 and Adhesive 3) had a pre-cure density under 1 gram per milliliter (g/ml) with example composition Adhesive 3 having the lowest pre-cure density of 0.88 g/ml.

Table 1 shows that each example of one component epoxy adhesive compositions having coated lightweight particles as fillers demonstrated wedge impact results (e.g., greater than 14 Newton per millimeter (N/mm)) at ambient temperature with compositions having less than one weight percent coated particles performing better (28.5 N/mm for example composition Adhesive 1 (0.4 wt %) and 21.7 N/mm for example composition Adhesive 2 (0.7 wt %)). Additionally, each example composition had a measured density of less than 1 g/ml and yielded T-peel test results greater than 3 N/mm. Example composition Adhesive 3 with a higher filler loading than example compositions Adhesive 1 and Adhesive 2 showed improved T-peel strength. Example compositions Adhesive 1 and Adhesive 2 demonstrated adhesive failure and Adhesive 3 demonstrated cohesive failure. Cohesive failure is generally preferred, because breakage occurs within the adhesive film leaving a partial coating of adhesive on both substrates.

TABLE 2
Effect of lightweight coated filler on wedge impact, T-peel, and
adhesive density in the presence of conventional weight fillers.

| | Adhesive 4 | | | |
|---|---|---|---|---|
| | (wt %) | Adhesive | Adhesive | Adhesive |
| | (comparative) | 5 (wt %) | 6 (wt %) | 7 (wt %) |
| Resins | | | | |
| Kane Ace MX-153⁹ | 64 | 63 | 63 | 63 |
| CAPA di-/MHHPA/Epon 828 | 11 | 11 | 11 | 11 |
| CAPA tetra-/MHHPA/Epon 828 | 13 | 13 | 13 | 13 |
| Fillers | | | | |
| Mica DakotaPure 3000¹⁰ | 2.7 | 2.6 | 2.6 | 2.6 |
| Calcium oxide¹¹ | 2.7 | 2.6 | 2.6 | 2.6 |
| Wacker HDK H17¹² | 0.40 | 0.40 | 0.40 | 0.39 |
| Coated particles ¹³ | — | 0.33 | 0.66 | 1.31 |
| Crosslinkers and catalysts | | | | |
| Dicyandiamide¹⁴ | 4.5 | 4.5 | 4.5 | 4.5 |
| Diuron¹⁵ | 0.40 | 0.40 | 0.40 | 0.40 |
| Ajicure PN-50¹⁶ | 1.3 | 1.3 | 1.3 | 1.3 |
| CRS Wedge impact (N/mm) | 23.5 ± 1.1 | 18.8 ± 3.2 | 16.7 ± 0.5 | 14.8 ± 1.0 |
| HDG T-peel (N/mm) | 4.9 ± 0.6 | 5.0 ± 1.5 | 6.1 ± 0.4 | 5.3 ± 0.1 |
| Failure mode | adhesive | adhesive | Cohesive | Cohesive |
| Density (g/mL) | 1.10 | 1.05 | 0.99 | 0.97 |

⁹33% Core shell rubber in unmodified, liquid epoxy resin based on Bisphenol-A available from Kaneka
¹⁰Potassium alumina silicate (mica) available from Pacer Corp.
¹¹Calcium oxide available from Mississippi Lime, Co.
¹²Hydrophobic Fumed Silica available from Wacker Chemie AG
¹³ Example 3
¹⁴Catalytically-active substituted urea available from Alz Chem
¹⁵3-(3,4-Dichlorophenyl)-1,1-dimethylurea available from Alz Chem
¹⁶Polymeric imidazole-based latent accelerator available from Ajinomoto Fine-Techno Co. Inc.

Table 2 compares one component epoxy adhesive compositions that either do not contain lightweight coated particles or compositions that include an amount of coated particles together with other particles or fillers. Table 2 shows that each composition that contained coated lightweight particles (example compositions Adhesive 5, Adhesive 6 and Adhesive 7) had a lower pre-cure density than the composition without any amount of coated lightweight particles (example composition Adhesive 4) and that compositions with a greater amount of coated lightweight particles having the lowest pre-cure density (example composition Adhesive 6 (0.99 g/mL) and example composition Adhesive 7 (0.97 g/mL)).

Table 2 shows that each example of one component epoxy adhesive compositions having coated lightweight particles demonstrated acceptable wedge impact results (e.g., about 14 N/mm or greater) with compositions having less than one weight percent coated particles performing better (18.8 N/mm for example composition Adhesive 5 (0.33 wt %) and 16.7 N/mm for example composition Adhesive 6 (0.66 wt %)) than a composition with greater than one weight percent coated particles (example composition Adhesive 7 (14.8 N/mm). One skilled in the art would understand that the addition of uncoated lightweight particles would result in impact resistance of less than 14 N/mm. The T-peel test results for each example composition were also acceptable with each example composition yielding a result greater than 3 N/mm. Higher coated particle loadings also improved the failure mode from adhesive to cohesive.

TABLE 3
Toughening effect of coated particles
on low temperature wedge impact.

| | | | Adhesive 9 |
|---|---|---|---|
| | Adhesive | Adhesive | (wt %) |
| | 8 (wt %) | 2 (wt %) | (comparative) |
| Resins | | | |
| Kane Ace MX-153¹⁷ | 60 | 67 | 67 |
| CAPA di-/MHHPA/Epon 828 | 10 | 12 | 12 |
| CAPA tetra-/MHHPA/Epon 828 | 12 | 14 | 14 |
| Flexibilizer DY 965¹⁸ | 6.2 | — | — |
| Fillers | | | |
| Mica Dakota Pure 3000¹⁹ | 2.5 | — | — |
| Calcium oxide²⁰ | 2.5 | — | — |
| Wacker HDK H17²¹ | 0.37 | — | — |
| Coated particles ²² | — | 0.70 | — |
| Expancel 461 DE20 D70²³ | — | — | 0.70 |
| (EZ-72-8074) | | | |
| Crosslinkers and catalysts | | | |
| Dicyandiamide²⁴ | 4.2 | 4.7 | 4.7 |
| Diuron²⁵ | 0.37 | 0.42 | 0.42 |
| Ajicure PN-50²⁶ | 1.2 | 1.4 | 1.4 |
| CRS Wedge impact (N/mm) | | | |
| Measured at: | | | |
| Ambient temperature | 21.4 ± 1.3 | 21.7 ± 0.1 | 12.8 ± 0.9 |
| 0° C. | 21.2 ± 0.5 | 18.6 ± 0.9 | 10.1 ± 0.7 |
| −40° C. | 19.2 ± 0.7 | 16.6 ± 0.1 | 3.7 ± 1.4 |

¹⁷33% Core shell rubber in unmodified, liquid epoxy resin based on Bisphenol-A available from Kaneka
¹⁸Polyurethane polyol available from Huntsman
¹⁹Potassium alumina silicate (mica) available from Pacer Corp.
²⁰Calcium oxide available from Mississippi Lime, Co.
²¹Hydrophobic Fumed Silica available from Wacker Chemie AG
²²Example 3
²³ Uncoated expanded microspheres available from AkzoNobel
²⁴Catalytically-active substituted urea available from Alz Chem
²⁵3-(3,4-Dichlorophenyl)-1,1-dimethylurea available from Alz Chem
²⁶Polymeric imidazole-based latent accelerator available from Ajinomoto Fine-Techno Co. Inc.

Table 3 shows an effect of temperature on 1K epoxy adhesive compositions. In the example compositions presented in Table 3, example composition Adhesive 8 is an epoxy adhesive composition including conventional fillers as well as an amount of a flexibilizer, Flexibilizer DY965, a polyurethane resin that offers high-impact resistance and improved adhesion to metals. Flexibilizer contributions to epoxy adhesive composition include improved wedge impact performance particularly at low temperature. Example composition Adhesive 8 did not include any coated particles. Example composition Adhesive 2 is the epoxy adhesive composition presented in Table 1 and contains filler only of coated particles (0.70 wt %) and no flexibilizer. Example composition Adhesive 9 is an epoxy adhesive composition that contains filler only of uncoated lightweight particles (Expancel 461 DE20 D70 having a particle size of 15 microns (μm) to 25 μm and a true density of 70 kilograms per cubic meter (kg/m³).

Table 3 shows that, at ambient and lower temperatures, example composition Adhesive 2 containing only coated particles as filler demonstrates similar wedge impact performance to example composition Adhesive 8 that contains a flexibilizer, which has been shown to improve wedge impact performance particularly at low temperatures. Example composition Adhesive 2 containing the coated particles demonstrates significantly better performance than example composition Adhesive 9 containing the uncoated particles as filler at every temperature, with a greater disparity at low temperatures than ambient.

TABLE 4
Effect of lightweight particles in a 2K polyurethane
adhesive on wedge impact, T-peel, and density.

| | Adhesive 10 (g) | Adhesive | Adhesive | Adhesive 13 (g) |
|---|---|---|---|---|
| | (comparative) | 11 (g) | 12 (g) | (comparative) |
| Part A | | | | |
| Resins, diluents, and catalysts | | | | |
| Polyvest 110²⁷ | 25.6 | 25.6 | 25.6 | 25.6 |
| Jeffamine D230²⁸ | 5.1 | 5.1 | 5.1 | 5.1 |
| 1,2-dimethylimidazole²⁹ | 1.5 | 1.5 | 1.5 | 1.5 |
| Diethylene glycol³⁰ | 4.0 | 4.0 | 4.0 | 4.0 |
| Poly BD R45 HT LO³¹ | 125.0 | 125.0 | 125.0 | 125.0 |
| Fillers | | | | |
| NYAD 400³² | 225.0 | 40.0 | — | — |
| Coated particles ³³ | — | 5.5 | 5.0 | |
| Expancel 461 DE20 D70³⁴ | — | — | — | 8.0 |
| Part B | | | | |
| Resins and plasticizers | | | | |
| Jayflex DINP³⁵ | 20.1 | 20.1 | 20.1 | 20.1 |
| Poly BD R45 HT LO | 34.3 | 34.3 | 34.3 | 34.3 |
| Polyvest 110 | 68.0 | 68.0 | 68.0 | 68.0 |
| Desmodur VK5³⁶ | 37.80 | 37.80 | 37.80 | 37.80 |
| Fillers | | | | |
| NYAD 400 | 225.0 | 40.0 | — | — |
| Coated particles | — | 5.5 | 5.0 | |
| Expancel 461 DE20 D70 | — | — | — | 8.0 |
| #1922 Spheriglass solid A³⁷ | 1.0 | 1.0 | 1.0 | 1.0 |
| HDG T-peel (N/mm) | 0.93 ± 0.14 | 0.86 ± 0.04 | 0.88 ± 0.03 | 0.98 ± 0.05 |
| CRS Wedge impact (N/mm) | | | | |
| Measured at: | | | | |
| Ambient temperature | 9.1 ± 3.6 | 6.8 ± 2.0 | 5.1 ± 1.8 | 8.6 ± 0.7 |
| −40° C. | 18.4 ± 7.8 | 15.6 ± 5.9 | 18.9 ± 4.4 | 10.8 ± 1.6 |
| Density (g/mL) - part A | 12.1 | 7.3 | 6.4 | 4.8 |
| Density (g/mL) - part B | 12.6 | 7.6 | 6.7 | 5.1 |

²⁷Polybutadiene available from Evonik
²⁸Polyoxypropylene diamine available from Huntsman Corporation
²⁹Available from MilliporeSigma
³⁰Available from Shell Chemical Co.
³¹Hydroxyterminated polybutadiene available from Cray Valley
³²Wollastonite (calcium metasilicate) available from Imerys, NYCO Division
³³ Example 3
³⁴Uncoated expanded microspheres available from AkzoNobel
³⁵Diisononyl phthalate available from Exxon Mobile
³⁶Mixture of diphenylmethane-4,4′-diisocyanate (MDI) with isomers and higher functional homologues (PMDI) available from Covestro
³⁷Soda-lime solid glass beads available from Potters Industries

Table 4 presents four examples of two component polyurethane adhesive compositions, each containing a Part A component and a Part B component. In Table 4, comparative example composition Adhesive 10 does not contain any amount of lightweight particles but instead includes a conventional filler (NYAD 400). Example composition Adhesive 11 contains a combination of conventional filler (NYAD 400) and coated lightweight particles. Example composition Adhesive 12 contains coated lightweight particles as a filler (10 grams in example composition Adhesive 12) and comparative example composition Adhesive 13 contains uncoated lightweight particles (Expancel 461 DE20 D70) as filler (16 grams in example composition Adhesive 13). Each of the example compositions also includes soda-lime solid glass beads (#1922 Spheriglass solid A in Part B).

Table 4 shows that each example composition containing coated lightweight particles (Adhesive 11 and Adhesive 12) had a significantly lower pre-cure density in both Part A and Part B of the adhesive composition than comparative example composition Adhesive 10 that did not contain any coated particles. Example compositions Adhesive 12 and Adhesive 13 show that coated particles (Adhesive 12) improved the low temperature wedge impact resistance of an adhesive composition compared to uncoated particles (Adhesive 13).

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims and aspects appended and any and all equivalents thereof.

1. An adhesive composition comprising:
an adhesive compound; and
a plurality of particles each comprising an exterior surface comprising a coating deposited thereon, wherein the coating comprises a thermoset material and/or a reaction product of reactants comprising the thermoset material and a material comprising additional functional groups in addition to those present on the thermoset material.

2. The adhesive composition of claim 1, wherein the thermoset material comprises an aminoplast resin, a thermoset polyester, a vinyl ester, an epoxy, a phenol, a polyurethane and combinations thereof.

3. The adhesive composition of claim 1, wherein the additional functional groups comprise hydroxy functional groups and/or amine functional groups.

4. (canceled)

5. The adhesive composition of claim 1, wherein the coating comprises a film thickness of and/or wherein each of the particles comprise the coating on at least 70 percent of a surface area of the particle.

6. (canceled)

7. (canceled)

8. (canceled)

9. The adhesive composition of claim 1, wherein, exclusive of the coating, the plurality of particles comprise a specific gravity of 0.7 or less as measured by ASTM D5965.

10. The adhesive composition of claim 1, wherein the plurality of particles comprise thermally expandable particles, such as thermally expandable hollow particles.

11. The adhesive composition of claim 1, wherein the adhesive compound comprises a thermoplastic polymer, a thiol-terminated compound, a hydrolysable component, a molecule comprising an electrophilic functional group or combinations thereof.

12. The adhesive composition of claim 11, wherein the molecule comprising the electrophilic functional group comprises an epoxy-containing compound, a carbonate-containing compound, an isocyanate-containing compound or combinations thereof and/or wherein the adhesive compound further comprises a second molecule comprising a nucleophilic functional group.

13. (canceled)

14. The adhesive composition of claim 12, wherein the nucleophilic functional group comprises an amine-containing compound, a thiol-containing compound, a hydroxy-containing compound, a carboxylic acid-containing compound, an anhydride-containing compound or combinations thereof.

15. The adhesive composition of claim 14, wherein the amine-containing compound comprises a diamine comprising a cyclic ring and/or a polyamine comprising a cyclic ring, wherein the cyclic ring of the diamine and/or the polyamine comprises at least one carbon positioned between the amino functional groups and the cyclic ring structure.

16. (canceled)

17. (canceled)

18. (canceled)

19. (canceled)

20. The adhesive composition of claim 1, wherein the adhesive composition further comprises elastomeric particles, an accelerator, an additive and/or a filler that is different than the plurality of particles, wherein the filler optionally comprises a specific gravity of greater than 0.7 as measured by ASTM D5965.

21. (canceled)

22. The adhesive composition of claim 1, wherein the composition comprises the plurality of particles in an amount of 0.05 percent by weight to 15 percent by weight based on total weight of the composition and/or wherein the composition comprises the adhesive compound in an amount of 85 percent by weight to 99.95 percent by weight based on total weight of the composition.

23. (canceled)

24. The composition of claim 1, wherein the adhesive composition comprises a one-component composition.

25. The composition of claim 1, wherein the adhesive composition comprises a two-component composition.

26. (canceled)

27. The composition of claim 1, wherein the adhesive composition comprises (i) a density that is at least 10 percent lower than adhesive compositions that comprise conventional fillers but not the plurality of coated particles disclosed herein and wherein an adhesive formed from the adhesive composition, in at least partially cured state, comprises (ii) a resistance to cleavage fracture or wedge impact at 25° C. of greater than 10 Newtons per millimeter (N/mm) and/or (iii) a resistance to cleavage fracture or wedge impact at −40° C. of greater than 3 N/mm measured according to ISO 11343 on 0.75 mm thick cold rolled steel (CRS).

28. The composition of claim 1, wherein the adhesive composition comprises (i) a density that is at least 10 percent lower than adhesive compositions that comprise conventional fillers but not the plurality of coated particles disclosed herein and wherein an adhesive formed from the adhesive composition, in at least partially cured state, comprises (ii) a resistance to cleavage fracture or wedge impact at 25° C. of greater than 3 N/mm measured according to ISO 11343 on 0.75 mm thick cold rolled steel (CRS).

29. The composition of claim 1, wherein the adhesive composition comprises (i) a density of less than 1.1 pounds/gal measured according to ASTM D5965 and wherein an adhesive formed from the adhesive composition may, in at least partially cured state, comprise (ii) a resistance to cleavage fracture or wedge impact at 25° C. of greater than 14 N/mm measured according to ISO 11343 on 0.75 mm thick cold rolled steel (CRS) and/or (iii) a resistance to cleavage fracture or wedge impact at −40° C. of greater than 3 N/mm measured according to ISO 11343 on 0.75 mm thick cold rolled steel (CRS), and/or (iv) a relative peel resistance or T-Peel of greater than 2 N/mm measured according to ASTM D1876 on 0.79 mm thick hot dip galvanized (HDG) steel.

30. The adhesive composition of claim 1, wherein the adhesive composition comprises (i) a density of less than 6 pounds/gal measured according to ASTM D5965 and wherein an adhesive formed from the adhesive composition, in an at least partially cured state, comprises (ii) a resistance to cleavage fracture or wedge impact at 25° C. of greater than 3 N/mm measured according to ISO 11343 on 0.75 mm thick cold rolled steel (CRS) and/or (iii) a relative peel resistance or T-Peel of greater than 0.5 N/mm measured according to ASTM D1876 on 0.79 mm thick hot dip galvanized (HDG) steel.

31. (canceled)

32. (canceled)

33. An assembly comprising:
a first substrate;
a second substrate; and
an adhesive comprising the adhesive composition of claim 1 in an at least partially cured state located between the first substrate and the second substrate.

34. A substrate wherein a surface of the substrate is at least partially coated with an adhesive formed from the adhesive composition of claim 1.

35. (canceled)
